(19) United States
(12) Patent Application Publication
(10) Pub. No.: US 2025/0381479 A1
(43) Pub. Date: Dec. 18, 2025

(54) INTERACTION METHOD AND APPARATUS BASED ON VIRTUAL BILLBOARD, ELECTRONIC DEVICE, AND STORAGE MEDIUM

(71) Applicant: Tencent Technology (Shenzhen) Company Limited, Shenzhen (CN)

(72) Inventor: Yu LI, Shenzhen (CN)

(21) Appl. No.: 19/313,704

(22) Filed: Aug. 28, 2025

Related U.S. Application Data
(63) Continuation of application No. PCT/CN2024/084266, filed on Mar. 28, 2024.

(30) Foreign Application Priority Data
May 26, 2023 (CN) 202310606646.3

(51) Int. Cl. A63F 13/52; A63F 13/61

(52) U.S. Cl. CPC A63F 13/52; A63F 13/61

(57) ABSTRACT

This application provides an interaction method on a virtual billboard performed by a computer device. The virtual billboard in the virtual scene highlights and prompts a first virtual object meeting the announcement condition, to prevent a user from ignoring information related to the first virtual object, thereby improving information utilization and information obtaining efficiency of the user in the virtual battle. A quick interaction path based on the virtual billboard is provided without affecting a display function of the virtual billboard. The user can initiate the challenge operation on the first virtual object based on the virtual billboard. When the challenge operation is performed on the first virtual object, the second virtual object is automatically controlled to move towards the first virtual object, to rapidly position and pursue the first virtual object to enable efficient interaction between the virtual objects, thereby improving human computer interaction efficiency.

### CROSS-REFERENCE TO RELATED APPLICATIONS

This application is a continuation application of PCT Patent Application No. PCT/CN2024/084266, entitled “INTERACTION METHOD AND APPARATUS BASED ON VIRTUAL BILLBOARD, ELECTRONIC DEVICE, AND STORAGE MEDIUM” filed on Mar. 28, 2024, which claims priority to Chinese Patent Application No. 202310606646.3, entitled “INTERACTION METHOD AND APPARATUS BASED ON VIRTUAL BILLBOARD, ELECTRONIC DEVICE, AND STORAGE MEDIUM” filed with the China National Intellectual Property Administration on May 26, 2023, both of which are incorporated herein by reference in their entirety.

### FIELD OF THE TECHNOLOGY

This application relates to the field of computer technologies, and in particular, to interaction technologies based on a virtual billboard.

### BACKGROUND OF THE DISCLOSURE

With development of computer technologies, a user can play a game on a terminal at any time in any place. In a common multiplayer confrontation game, a user enters a virtual scene in a game application, and controls a virtual object of the user to interact with another virtual object in a form such as cooperation or confrontation.

When a map of the virtual scene is relatively large, the user usually needs to interact with some particular virtual objects, for example, a virtual object that ranks high in a battle ranking list, or a virtual object that possesses a special prop, or a virtual object that has many virtual resources. However, although a system may prompt in broadcast mode, the user needs to find a particular virtual object in the virtual scene before the interaction. As a result, information obtaining efficiency, information utilization, and human computer interaction efficiency of the user are low.

### SUMMARY

Embodiments of this application provide an interaction method and apparatus based on a virtual billboard, an electronic device, and a storage medium, to improve information utilization, information obtaining efficiency, and human computer interaction efficiency of users in virtual battles. The technical solutions are as follows:

According to one aspect, an interaction method on a virtual billboard is performed by a computer device, the method including:
displaying a virtual billboard in a virtual scene, the virtual billboard including at least one first virtual object meeting an announcement condition in a virtual battle; and
in response to a challenge operation performed on the first virtual object, controlling a second virtual object to move towards the first virtual object.

According to one aspect, an electronic device is provided, where the electronic device includes one or more processors and one or more memories, the one or more memories have at least one computer program stored therein, and the at least one computer program is loaded and executed by the one or more processors to implement the interaction method based on a virtual billboard in any one of the foregoing possible implementations.

According to one aspect, a non-transitory computer-readable storage medium is provided, where the computer-readable storage medium has at least one computer program stored therein, and the at least one computer program is loaded and executed by a processor to implement the interaction method based on a virtual billboard in any one of the foregoing possible implementations.

According to one aspect, a computer program product is provided, where the computer program product includes one or more computer programs, and the one or more computer programs are stored in a non-transitory computer-readable storage medium. One or more processors of an electronic device can read the one or more computer programs from the computer readable storage medium, and the one or more processors execute the one or more computer programs, so that the electronic device can perform the interaction method based on a virtual billboard in any one of the foregoing possible implementations.

The technical solutions provided in the embodiments of this application have at least the following beneficial effects:

The virtual billboard set in the virtual scene highlights and prompts the first virtual object meeting the announcement condition, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. That is, the user can initiate the challenge operation on the displayed first virtual object directly based on the virtual billboard, to automatically and directly control the second virtual object to move towards the first virtual object to be challenged, and rapidly position and pursue the first virtual object to enable efficient interaction between the virtual objects. First virtual objects do not need to be searched for one by one in the virtual scene, and instead the first virtual object can be quickly positioned based on the announcement of the virtual billboard, thereby improving human computer interaction efficiency.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram of an implementation environment of an interaction method based on a virtual billboard according to an embodiment of this application;

FIG. 2 is a flowchart of an interaction method based on a virtual billboard according to an embodiment of this application;

FIG. 3 is a flowchart of an interaction method based on a virtual billboard according to an embodiment of this application;

FIG. 4 is a schematic diagram of a virtual billboard according to an embodiment of this application;

FIG. 5 is a schematic diagram of a virtual billboard according to an embodiment of this application;

FIG. 6 is a schematic diagram of a query control according to an embodiment of this application;

FIG. 7 is a schematic diagram of a query control according to an embodiment of this application;

FIG. 8 is a schematic diagram of an interface of an airdrop manner according to an embodiment of this application;

FIG. 9 is a schematic diagram of a special effect of marking a first virtual object according to an embodiment of this application;

FIG. 10 is a flowchart of an interaction method based on a virtual billboard according to an embodiment of this application;

FIG. 11 is a schematic diagram of a mode selection control according to an embodiment of this application;

FIG. 12 is a flowchart of an interaction method based on a virtual billboard according to an embodiment of this application;

FIG. 13 is an interactive flowchart of an interaction method based on a virtual billboard according to an embodiment of this application;

FIG. 14 is an interactive flowchart of an interaction method based on a virtual billboard according to an embodiment of this application;

FIG. 15 is a schematic structural diagram of an interaction apparatus based on a virtual billboard according to an embodiment of this application;

FIG. 16 is a schematic structural diagram of an interaction apparatus based on a virtual billboard according to an embodiment of this application;

FIG. 17 is a schematic structural diagram of an interaction apparatus based on a virtual billboard according to an embodiment of this application;

FIG. 18 is a schematic structural diagram of an electronic device according to an embodiment of this application; and

FIG. 19 is a schematic structural diagram of an electronic device according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and the like in this application are used for distinguishing between same items or similar items whose effects and functions are basically the same. The “first”, “second”, and “nth” do not have a dependency relationship in logic or time sequence, and a quantity and an execution order thereof are not limited.

In this application, the term “at least one” refers to one or more, and “a plurality of” refers to two or more. For example, a plurality of display areas refer to two or more display areas.

In this application, the term “including at least one of A or B” involves the following several cases: including only A, including only B, and including both A and B.

User-related information (including but not limited to device information, personal information, behavior information, and the like of a user), data (including but not limited to data used for analysis, stored data, displayed data, and the like), and a signal in this application are all licensed, approved, authorized by the user, or fully authorized by all parties when the method in the embodiments of this application is applied to a specific product or technology, and collection, use, and processing of the related information, the data, and the signal need to comply with related laws, regulations, and standards of a related country and region. For example, control operations performed on a virtual object involved in this application are all obtained with sufficient authorization.

Terms involved in this application are explained below.

Shooter game (STG): A shooter game is a type of game in which a virtual object performs a remote attack by using a virtual shooting prop. A shooter game is a type of action game, and has very clear characteristics of an action game. In some embodiments, the shooter game includes but is not limited to: a first-person shooting (FPS) game, a third-person shooting (TPS) game, a top-down view shooting game, a head-up shooting game, a platform shooting game, a scroll shooting game, a keyboard and mouse shooting game, a shooting range game, and the like. Types of shooter games are not specifically limited in the embodiments of this application.

In the FPS game, a game is played based on the subjective field of view of a main control virtual object (that is, a game character) of a user, and unlike other types of games, the entire main control virtual object usually cannot be seen. In the FPS game, in addition to a virtual scene and an enemy virtual object, the user usually can only see two hands of the main control virtual object and a virtual prop held on the hands, or the user cannot see the main control virtual object. Compared with the FPS game, a field of view of the TPS game moves beyond the main control virtual object, and is usually in the back area or the rear shoulder area of the main control virtual object. In the TPS game, a user can see a full-body model or a half-body model of the main control virtual object, and can usually switch between two statuses: a hip shooting mode (shooting without turning on a sight, that is, shooting directly without turning on an aiming sight) and an aiming down sight (ADS) (that is, turn on the aiming sight and adjust a front sight before shooting) mode during shooting. The FPS game and the TPS game are two main forms of current shooting games, and core experience of both the two types of games is searching for and shooting a target.

Virtual scene: A virtual scene is a virtual environment displayed (or provided) when an application program runs on a terminal. The virtual scene can be a simulation environment of the real world, a semi-simulation and semi-fictitious virtual environment, or a purely fictitious virtual environment. The virtual scene may be any one of a two-dimensional virtual scene, a 2.5-dimensional virtual scene, or a three-dimensional virtual scene. The embodiments of this application do not limit the dimension of the virtual scene. For example, the virtual scene can include sky, land, and ocean. The land can include environmental elements such as deserts and cities, and a user can control a virtual object to move in the virtual scene. In some embodiments, the virtual scene may be further used for a virtual scene confrontation between at least two virtual objects, and there are virtual resources available to the at least two virtual objects in the virtual scene.

Virtual object: A virtual object is a movable object in a virtual scene. The movable object can be a player character controlled by a user through operation on an application program, a non-player character (NPC) that can interact in a virtual scene, a neutral virtual object (for example, a wild monster that provides resources such as buffs and experience points), or a game robot that is not controlled by a user in a virtual scene (for example, a companion robot). Illustratively, the virtual object is a virtual avatar, such as a virtual character, a virtual animal, or an animation character used to represent a user in the virtual scene. The virtual scene may include a plurality of virtual objects, and each virtual object has a shape and a volume in the virtual scene, and occupies some space in the virtual scene. In some embodiments, when the virtual scene is a three-dimensional virtual scene, the virtual object may be a three-dimensional model, and the three-dimensional model is a three-dimensional character built based on a three-dimensional human skeleton technology. The same virtual object may show different external appearances by wearing different skins. In some embodiments, the virtual object may be alternatively implemented by using a 2.5-dimensional model or a two-dimensional model. This is not limited in the embodiments of this application.

In some embodiments, in a multiplayer confrontation game, the virtual object is a virtual character competing in a virtual scene. In some embodiments, a quantity of virtual objects participating in a virtual battle in the virtual scene may be preset or dynamically determined based on a quantity of terminals joining the virtual battle.

Virtual billboard: A virtual billboard is a display tool that is set in a virtual scene to provide a bulletin/announcement function, for example, a virtual billboard includes, but is not limited to: a virtual advertisement board, a virtual television, a virtual screen, a virtual canvas, a virtual newspaper column, a virtual projection, a virtual curtain, a virtual screen projection, a virtual television wall, a virtual road sign, and the like. This is not specifically limited in the embodiments of this application.

Ideas of the embodiments of this application are described below.

In a conventional FPS game, a user usually needs to interact with some particular virtual objects, for example, a virtual object that ranks high in a battle ranking list, or a virtual object that possesses a special prop, or a virtual object that has many virtual resources. However, although a system may prompt in broadcast mode, the user needs to find a particular virtual object in the virtual scene before the interaction. As a result, information obtaining efficiency, information utilization, and human computer interaction efficiency of the user are low.

Illustratively, in an FPS game, a battle ranking list is usually established according to points for virtual objects participating in a virtual battle, so that a user learns of important information such as a ranking. To obtain more points to win a game, the user needs to interact with a particular virtual object that ranks high in the battle ranking list. However, the user may easily ignore information provided in the battle ranking list. That is, the user has low information utilization for the ranking list, and has low information obtaining efficiency. In addition, the user lacks ways of efficient interaction with other virtual objects in the battle ranking list, and has low human computer interaction efficiency.

In view of this, an embodiment of this application provides an interaction solution based on a virtual billboard. A virtual billboard in a virtual scene is used to highlight related information declared by a particular virtual object that meets an announcement condition, that is, a first virtual object. When the virtual object meets the announcement condition, the virtual object declares, in the virtual billboard, announcement information authorized by the virtual object, to prevent a user from ignoring the announcement information provided by the first virtual object, thereby improving information utilization and information obtaining efficiency of the user in a virtual battle. In addition, the user may directly start efficient interaction with the displayed first virtual object based on the virtual billboard, for example, approach the first virtual object for confrontation, thereby improving efficiency of human computer interaction between the user and the first virtual object in the virtual battle.

For example, the particular virtual object is the first virtual object whose ranking meets the announcement condition in the battle ranking list. In a virtual battle, the first virtual object whose ranking meets the announcement condition in the battle ranking list (there may be one or more first virtual objects) is displayed in a virtual billboard to highlight, to prevent a user from ignoring information provided by the battle ranking list, thereby improving ranking list information utilization and information obtaining efficiency of the user. In addition, the user may directly start efficient interaction with the displayed first virtual object based on the virtual billboard, for example, approach the first virtual object for confrontation, thereby improving efficiency of human computer interaction between the user and the first virtual object in the virtual battle.

In the foregoing process, a new information meaning and a new interaction path are provided to the virtual billboard. In this way, in addition to displaying some advertisement images, the virtual billboard can further display information of a player meeting an announcement condition in a current battle, for example, information of a player whose ranking is relatively high in a ranking list. Displayed information content is, for example, an appearance, an announced declaration, an avatar image, an account nickname, a live streaming image, or a challenge control of the first virtual object. Functions of the virtual billboard are strengthened and expanded, and a new interaction play method is additionally provided while ensuring a display function of the virtual billboard. Details of the interaction solution based on a virtual billboard is described in subsequent embodiments.

The following describes a system architecture in the embodiments of this application.

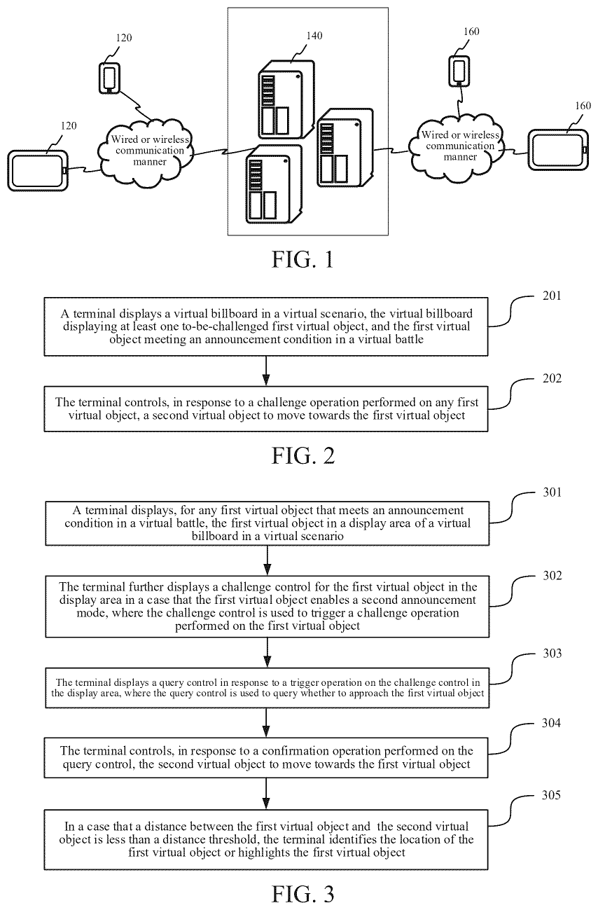

FIG. 1 is a schematic diagram of an implementation environment of an interaction method based on a virtual billboard according to an embodiment of this application. Referring to FIG. 1, the implementation environment includes: a first terminal 120, a server 140, and a second terminal 160. The first terminal 120 and the second terminal 160 may be directly or indirectly connected to the server 140 in a wired or wireless communication manner.

An application program supporting a virtual scene is installed and run on the first terminal 120. In some embodiments, the application program includes: any one of an FPS game, a TPS game, a virtual reality application program, a three-dimensional map program, or a multiplayer weapon survival game. In some embodiments, the first terminal 120 is a terminal used by a first user. When the application program is run on the first terminal 120, a user interface of the application program is displayed on a screen of the first terminal 120, and based on a battle start operation performed by the first user in the user interface, a virtual scene is loaded and displayed in the application program. The first user uses the first terminal 120 to operate a first virtual object in the virtual scene to perform an activity. The activity includes but is not limited to: at least one of adjusting a body posture, crawling, walking, running, riding, jumping, driving, picking, shooting, attacking, throwing, and confrontation. For example, the first virtual object may be a first virtual character such as a simulated character role or a cartoon character role.

The server 140 includes at least one of one server, a plurality of servers, a cloud computing platform, or a virtualization center. The server 140 is configured to provide a backend service for an application program supporting a virtual scene. In some embodiments, the server 140 performs primary computing work, and the first terminal 120 and the second terminal 160 perform secondary computing work. Alternatively, the server 140 performs secondary computing work, and the first terminal 120 and the second terminal 160 perform primary computing work. Alternatively, the server 140, the first terminal 120, and the second terminal 160 perform collaborative computing by using a distributed computing architecture.

In some embodiments, the server 140 is an independent physical server, or is a server cluster or a distributed system formed by a plurality of physical servers, or is a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

An application program supporting a virtual scene is installed and run on the second terminal 160. In some embodiments, the application program includes: any one of an FPS game, a TPS game, a virtual reality application program, a three-dimensional map program, or a multiplayer weapon survival game. In some embodiments, the second terminal 160 is a terminal used by a second user. When the application program is run on the second terminal 160, a user interface of the application program is displayed on a screen of the second terminal 160, and based on a battle start operation performed by the second user in the user interface, a virtual scene is loaded and displayed in the application program. The second user uses the second terminal 160 to operate a second virtual object in the virtual scene to perform an activity. The activity includes but is not limited to: at least one of adjusting a body posture, crawling, walking, running, riding, jumping, driving, picking, shooting, attacking, throwing, and confrontation. Illustratively, the second virtual object may be a second virtual character, such as a simulated character or a cartoon character.

In some embodiments, the first virtual object controlled by the first terminal 120 and the second virtual object controlled by the second terminal 160 are located in the same virtual scene, and in this case, the first virtual object may interact with the second virtual object in the virtual scene.

For example, the first virtual object and the second virtual object are in an enemy relationship. For example, the first virtual object and the second virtual object belong to different camps or teams. Virtual objects in an enemy relationship can interact in a confrontation form on land, for example, fire a shooting prop or throw a throwing prop to each other. In some other embodiments, the first virtual object and the second virtual object may be in a teammate relationship, for example, the first virtual object and the second virtual object may belong to the same camp or team, are friends, or have a temporary communication permission.

In some embodiments, the application programs installed on the first terminal 120 and the second terminal 160 are the same, or the application programs installed on the two terminals are the same type of application programs on different operating system platforms. Each of the first terminal 120 and the second terminal 160 may generally refer to one of a plurality of terminals, and in this embodiment of this application, only the first terminal 120 and the second terminal 160 are used as an example.

Device types of the first terminal 120 and the second terminal 160 are the same or different. The device types include: at least one of smartphones, tablet computers, smart speakers, smart watches, extended reality (XR) devices, virtual reality (VR) devices, augmented reality (AR) devices, mixed reality (MR) devices, smart handheld devices, portable gaming devices, in-vehicle terminals, laptop computers, and desktop computers, but are not limited thereto. For example, both the first terminal 120 and the second terminal 160 are smartphones, or other handheld portable game devices. The following embodiments are described by using an example in which a terminal includes a smartphone.

A person skilled in the art can learn that a quantity of the foregoing terminals is more or less. For example, there may be only one terminal, or there may be dozens, hundreds, or more terminals. The quantity and device types of the terminals are not limited in the embodiments of this application.

A basic procedure of an interaction method based on a virtual billboard according to an embodiment of this application is described below.

FIG. 2 is a flowchart of an interaction method based on a virtual billboard according to an embodiment of this application. Referring to FIG. 2, this embodiment is performed by an electronic device. The electronic device may be a terminal that operates a second virtual object. For example, the terminal may be provided as the first terminal 120 or the second terminal 160 in the foregoing implementation environment. This embodiment includes the following operations:

201: A terminal displays a virtual billboard in a virtual scene, the virtual billboard displaying at least one target first virtual object, and the first virtual object meeting an announcement condition in a virtual battle.

The terminal may be an electronic device that operates the second virtual object, and the virtual scene may be a virtual environment provided by an application program/application client run by the terminal.

The virtual billboard in this embodiment of this application is a display tool that is set in a virtual scene to provide a bulletin/announcement function, for example, the virtual billboard includes, but is not limited to: a virtual advertisement board, a virtual television, a virtual screen, a virtual canvas, a virtual newspaper column, a virtual projection, a virtual curtain, a virtual screen projection, a virtual television wall, a virtual road sign, and the like. This is not specifically limited in the embodiments of this application.

The first virtual object in this embodiment of this application is a virtual object that meets the announcement condition in the virtual battle. The announcement condition is determined based on game service logic.

The announcement condition in this embodiment of this application is a status condition in which the virtual object needs to be in the virtual battle to be displayed in the virtual billboard. For example, the announcement condition may be a ranking condition in which the virtual object needs to be in a battle ranking list to be displayed in the virtual billboard, or the announcement condition may be that the virtual object possesses or is equipped with a particular virtual prop in the virtual battle, or the announcement condition may be that the virtual object possesses or is equipped with a particular virtual material in a virtual battle, or the announcement condition may be that the virtual object spends a virtual resource in the virtual battle to exchange for a billboard display qualification. The battle ranking list may be a ranking list obtained by ranking points collected according to behaviors/operations of virtual objects in the virtual battle. A point collection rule is specified in game service logic. The announcement condition may be any one of the foregoing or a combination of at least two of the foregoing. The announcement condition is determined based on game service logic. A person skilled in the art may configure the announcement condition, for example, a plurality of manners of being displayed in the virtual billboard are supported. Specific content of the announcement condition is not specifically limited in this embodiment of this application.

In some embodiments, for example, the announcement condition is a ranking condition in which a virtual object needs to be in a battle ranking list to be displayed in the virtual billboard. In this case, the announcement condition may be ranking in the first place in the battle ranking list, or may be ranking in the first N places in the battle ranking list, where N≥1, or may be that a ranking of a virtual object increases by more than K places in a preset time period, where K is a preset value, for example, K is half of a quantity of participants. The ranking condition is not specifically limited in this embodiment of this application.

In some embodiments, a user starts a game application on a terminal, and a virtual scene is loaded and displayed in the game application in response to a battle start operation in the game application. In a case of a first-person perspective, for example, in a virtual scene of an FPS game, the second virtual object is usually not displayed, or only a part of the body of the second virtual object is displayed, for example, two hands of the second virtual object and a virtual prop held on the hands are displayed. In a case of a third-person perspective, for example, in a virtual scene of a TPS game, a full-body model or a half-body model of the second virtual object is usually displayed, but generally, the back area or the rear shoulder area of the second virtual object is displayed. Whether to display the second virtual object in the virtual scene and whether to display the full-body model of the second virtual object are not specifically limited in this embodiment of this application.

In some embodiments, the terminal displays, in the game application, a virtual scene located within a field of view (FoV) of the second virtual object, and displays the virtual billboard when the virtual billboard exists in the FoV of the second virtual object. Alternatively, a virtual billboard whose location does not change with movement of the second virtual object is continuously displayed in the FoV of the second virtual object. The location of the virtual billboard in the virtual scene is not specifically limited in this embodiment of this application.

In some embodiments, one or more target first virtual objects are displayed in the virtual billboard of the virtual scene. A quantity of first virtual objects in the virtual billboard depends on a quantity of participating virtual objects in the virtual battle that meet the announcement condition specified in the game service logic. The quantity of first virtual objects displayed in the virtual billboard is not specifically limited in this embodiment of this application. A specific display manner of the virtual billboard is described in subsequent embodiments, and details are not described herein again.

For example, the announcement condition is a ranking condition in which a virtual object needs to be in a battle ranking list to be displayed in the virtual billboard. Assuming that the ranking condition is ranking in the first place in the battle ranking list and the battle ranking list is a ranking list of individual points, only a virtual object that ranks in the first place can be displayed in the virtual billboard as the first virtual object. Therefore, only one first virtual object is displayed in the virtual billboard.

Further, in another case, the ranking condition is still ranking in the first place in the battle ranking list. However, the battle ranking list is a ranking list of ranking according to both individual and team points, that is, a user may select to participate as an individual, or may select to participate in a team, or may participate in a team at the beginning but other teammates have been eliminated. In this case, if an individual ranks in the first place, the individual (that is, a single first virtual object) that ranks in the first place is displayed in the virtual billboard, and if a team ranks in the first place, all teammates that have not been eliminated (that is, one or more first virtual objects) in the team that ranks in the first place are displayed in the virtual billboard.

For another example, the announcement condition is a ranking condition in which a virtual object needs to be in a battle ranking list to be displayed in the virtual billboard. Assuming that the ranking condition is ranking in the first N places in the battle ranking list, where N≥1, and the battle ranking list is a ranking list of individual points, all N virtual objects that rank in the first N places can be displayed in the virtual billboard as the first virtual objects. Therefore, only N first virtual objects are displayed in the virtual billboard. A specific quantity of displayed first virtual objects depends on a value of N.

Further, in another case, the ranking condition is still ranking in the first N places in the battle ranking list. If the battle ranking list is a ranking list of ranking according to both individual and team points, individuals or all teammates of teams that rank in the first N places are all displayed in the virtual billboard.

The first virtual object and the second virtual object are merely used for distinguishing a virtual object operated by a terminal and a virtual object displayed in the virtual billboard. However, the first virtual object and the second virtual object may be the same virtual object. For example, an appearance of the first virtual object can be naturally seen in the virtual billboard displayed on the terminal that operates the first virtual object. Certainly, the first virtual object and the second virtual object may alternatively be different virtual objects. This is not specifically limited in this embodiment of this application.

202: The terminal controls, in response to a challenge operation performed on any first virtual object, a second virtual object to move towards the first virtual object.

In some embodiments, the terminal detects whether the user performs a challenge operation on any virtual object displayed in the virtual billboard, and if detecting a challenge operation performed by the user on any first virtual object, the terminal may control the second virtual object to move towards the first virtual object. For example, the second virtual object is controlled to move towards the first virtual object according to an automatic navigation route, or the second virtual object is controlled to perform airdrop to a movement area or a preset range of the first virtual object, or the second virtual object is controlled to transfer to a preset range of the first virtual object. A moving manner of the second virtual object is not specifically limited herein, and details of a moving manner are described in subsequent embodiments.

When the challenge operation is performed on any first virtual object, to avoid that the challenge operation is accidentally performed by the user, in some embodiments, a manner of controlling the second virtual object to move towards the first virtual object in response to a challenge operation performed on any first virtual object may be: displaying a query control in response to the challenge operation performed on any first virtual object, where the query control is used to query whether to move towards the first virtual object, and controlling the second virtual object to move towards the first virtual object in response to a confirmation operation performed on the query control.

In this embodiment of this application, if a challenge operation performed by the user on any first virtual object is detected, a query control may pop up, and the user may further determine, by using the query control, whether to move towards the first virtual object. This effectively avoids moving close to a first virtual object due to accidental trigger of the virtual billboard by the user, thereby reducing an accidental trigger rate of the user.

In some embodiments, one or more first virtual objects may be displayed in the virtual billboard. A process of initiating challenge against any first virtual object is used as an example for description. A user may initiate a challenge operation on a display area of the first virtual object in the virtual billboard. A specific triggering manner is described in detail in subsequent embodiments, and is not described in detail again. Alternatively, the user may perform a triggering operation on the entire virtual billboard, then a virtual object selection pop-up window pops up, all selectable first virtual objects are displayed in the virtual object selection pop-up window, and then the user selects a target first virtual object in the virtual object selection pop-up window, to initiate a challenge operation on the first virtual object. A triggering procedure of the challenge operation is not specifically limited in this embodiment of this application.

In some embodiments, the terminal displays a query control in the virtual scene in response to a challenge operation performed by the user on any first virtual object. For example, the query control directly pops up in the virtual scene, or the query control is displayed based on the virtual billboard. A display location of the query control is not specifically limited in this embodiment of this application. Further, a display manner of the query control is described in detail in subsequent embodiments, and details are not described again.

In some embodiments, the user of the terminal may perform a confirmation operation or a cancellation operation on the query control. If the terminal detects that the user performs the confirmation operation on the query control, it indicates that the user confirms for the second time, and the second virtual object is controlled by the terminal to move towards the first virtual object.

In some other embodiments, if detecting that the user performs a cancellation operation on the query control, the terminal may fold the query control, so that the user can trigger or call the query control again when subsequently wanting to find the first virtual object. Certainly, the query control may alternatively be directly hidden, to avoid that the query control blocks the virtual scene. This is not specifically limited in this embodiment of this application.

Any combination of the foregoing technical solutions may be used to obtain an embodiment of the present disclosure. Details are not described herein.

In the method provided in the embodiments of this application, the virtual billboard set in the virtual scene highlights and prompts the first virtual object meeting the announcement condition, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. That is, the user can initiate the challenge operation on the displayed first virtual object directly based on the virtual billboard, to automatically and directly control the second virtual object to move towards the first virtual object to be challenged, and rapidly position and pursue the first virtual object to enable efficient interaction between the virtual objects. First virtual objects do not need to be searched for one by one in the virtual scene, and instead the first virtual object can be quickly positioned based on the announcement of the virtual billboard, thereby improving human computer interaction efficiency.

When the announcement condition is related to a ranking in the battle ranking list, the virtual billboard set in the virtual scene is used to highlight and prompt the first virtual object whose ranking meets the announcement condition in the battle ranking list, to prevent the user from ignoring information provided by the battle ranking list, thereby improving ranking list information utilization and information obtaining efficiency of the user. Because the virtual billboard is set in the virtual scene and integrates well with terrains or facilities of the virtual scene, abrupt display of the first virtual object is avoided, thereby ensuring immersive game experience of the user.

In the foregoing embodiment, a basic procedure of how the second virtual object initiates challenge against the first virtual object according to the virtual billboard is briefly described. In the embodiments of this application, details of the procedure for initiating the challenge are described below.

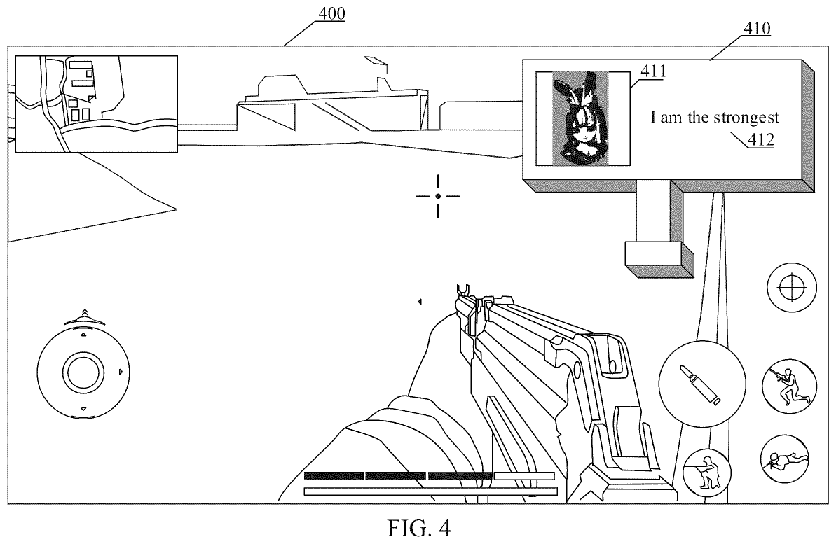

FIG. 3 is a flowchart of an interaction method based on a virtual billboard according to an embodiment of this application. Referring to FIG. 3, this embodiment is performed by an electronic device. The electronic device may be a terminal that operates a second virtual object. For example, the terminal may be provided as the first terminal 120 or the second terminal 160 in the foregoing implementation environment. This embodiment includes the following operations:

301: A terminal displays, for any first virtual object that meets an announcement condition in a virtual battle, the first virtual object in a display area of a virtual billboard in a virtual scene.

In some embodiments, a game server may define specific content of the announcement condition in game service logic for any virtual battle. The announcement condition is a status condition in which a virtual object needs to be in the virtual battle to be displayed in the virtual billboard. In some embodiments, the announcement condition includes but is not limited to any one of the following or a combination of at least two of the following: a ranking condition in which a virtual object needs to be in a battle ranking list to be displayed in the virtual billboard; a virtual object possesses or is equipped with a particular virtual prop in a virtual battle; a virtual object possesses or is equipped with a particular virtual material in a virtual battle; and a virtual object spends a virtual resource in a virtual battle to exchange for a billboard display qualification. Specific content of the announcement condition is not specifically limited in this embodiment of this application.

In some embodiments, for example, the announcement condition is a ranking condition in which a virtual object needs to be in a battle ranking list to be displayed in the virtual billboard. In this case, the game server may maintain a battle ranking list for all virtual objects participating in the virtual battle. The battle ranking list is a ranking list obtained by ranking points collected according to behaviors/operations of virtual objects in the virtual battle. A point collection rule is specified in game service logic. For example, a preset quantity of points are obtained each time one virtual object is eliminated, and additional reward points are obtained when a plurality of virtual objects are continuously eliminated within a specified time period. The point collection rule is not specifically limited herein.

In some embodiments, a unit participating in ranking of the battle ranking list may be an individual or a team. If only an individual is allowed to participate in the ranking, all virtual objects are ranked in descending order of points in the battle ranking list. If both an individual and a team are allowed to participate in the ranking, a virtual object may participate in the battle independently or participate in the battle after joining a team, where the team includes at least one teammate. In this case, all virtual objects are ranked in the battle ranking list according to points (individual points or sums of points of all teammates in teams, that is, team points). A point ranking rule of the battle ranking list is not specifically limited in this embodiment of this application.

In some embodiments, the battle ranking list is updated or refreshed in real time as the virtual battle is performed, and the game server promptly synchronizes/delivers the refreshed battle ranking list to terminals participating in the virtual battle. In this embodiment of this application, only a ranking status of the battle ranking list at a specific moment is used as an example for description. In the battle ranking list at a specific moment, one or more first virtual objects whose rankings meet the announcement condition are determined. The determining operation may be performed by the game server, or may be performed by a terminal according to the obtained battle ranking list. An execution entity is not specifically limited herein.

The battle ranking list is described above by using an example in which the announcement condition is a ranking condition in which a virtual object needs to be in a battle ranking list to be displayed in the virtual billboard. In some embodiments, the announcement condition includes but is not limited to: a virtual object or a team of the virtual object ranks in the first place in the battle ranking list; or a virtual object or a team of the virtual object ranks in the first N places in the battle ranking list, where N≥1; or a ranking of a virtual object increases by more than K places in a preset time period, where K is a preset value, for example, K is half of a quantity of participants. The ranking condition is not specifically limited in this embodiment of this application.

In some embodiments, a user starts a game application in a terminal, and in response to a battle start operation performed on the game application, a virtual scene within an FoV of a second virtual object is displayed in the game application, and a virtual billboard is displayed in the virtual scene. In some embodiments, the virtual billboard is displayed when the virtual billboard exists in the FoV of the second virtual object. Alternatively, a virtual billboard whose location does not change with movement of the second virtual object is continuously displayed in the FoV of the second virtual object. The location of the virtual billboard in the virtual scene is not specifically limited in this embodiment of this application.

When the virtual billboard is displayed in the virtual scene, after the first virtual object that meets the announcement condition in the virtual battle at a current moment is determined, at least one target first virtual object is displayed in the virtual billboard. A quantity of first virtual objects in the virtual billboard depends on a quantity of participating virtual objects in the virtual battle that meet the announcement condition specified in the game service logic. The quantity of first virtual objects displayed in the virtual billboard is not specifically limited in this embodiment of this application. For example, when the announcement condition is a ranking condition in which a virtual object needs to be in a battle ranking list to be displayed in the virtual billboard, one or more first virtual objects that meet the ranking condition may be determined according to rankings in the battle ranking list.

For example, the announcement condition is a ranking condition in which a virtual object needs to be in a battle ranking list to be displayed in the virtual billboard. Assuming that the ranking condition is ranking in the first place in the battle ranking list and the battle ranking list is a ranking list of individual points, only a virtual object that ranks in the first place can be displayed in the virtual billboard as the first virtual object. Therefore, only one first virtual object is displayed in the virtual billboard.

Further, in another case, the ranking condition is still ranking in the first place in the battle ranking list. However, the battle ranking list is a ranking list of ranking according to both individual and team points, that is, a user may select to participate as an individual, or may select to participate in a team, or may participate in a team at the beginning but other teammates have been eliminated. In this case, if an individual ranks in the first place, the individual (that is, a single first virtual object) that ranks in the first place is displayed in the virtual billboard, and if a team ranks in the first place, all teammates that have not been eliminated (that is, one or more first virtual objects) in the team that ranks in the first place are displayed in the virtual billboard.

For another example, the announcement condition is a ranking condition in which a virtual object needs to be in a battle ranking list to be displayed in the virtual billboard. Assuming that the ranking condition is ranking in the first N places in the battle ranking list, where N≥1, and the battle ranking list is a ranking list of individual points, all N virtual objects that rank in the first N places can be displayed in the virtual billboard as the first virtual objects. Therefore, only N first virtual objects are displayed in the virtual billboard. A specific quantity of displayed first virtual objects depends on a value of N.

Further, in another case, the ranking condition is still ranking in the first N places in the battle ranking list. If the battle ranking list is a ranking list of ranking according to both individual and team points, individuals or all teammates of teams that rank in the first N places are all displayed in the virtual billboard.

In operation 301, only an example in which the virtual billboard includes at least one display area and each display area is used to display one target first virtual object is used to describe a possible implementation of displaying the virtual billboard in the virtual scene. In this way, each first virtual object occupies a relatively independent display area in the virtual billboard, so that each first virtual object is highlighted in the virtual billboard, to prevent the user from missing each first virtual object worthy of attention. Therefore, the user can develop a targeted confrontation strategy or directly airdrop to challenge, thereby improving the competitiveness, confrontation, and strategic nature of the game. The virtual billboard is used as an important display tool in the virtual scene. Because the virtual billboard can naturally integrate with the virtual scene and does not generate an abrupt visual effect, ranking information obtaining efficiency, ranking information utilization, and human computer interaction efficiency of the user are improved while avoiding interrupting or disrupting immersive experience of the user.

In some other embodiments, in addition to allocating a display area to each first virtual object in the virtual billboard, a display area may also be allocated based on a team as a unit. In this case, if a first virtual object participates as an individual, the first virtual object merely needs to be processed as a single team. In this way, teammates of the same team are all displayed in the same display area, thereby preventing the user from neglecting a cooperative relationship between teammates of the same team, and further facilitating the user to develop a confrontation strategy. In this way, in addition to ranking list information of the first virtual object, the display area additionally carries the team of the first virtual object and relationship information of the teammates of the team. This improves an information amount carried in each display area, and further improves information obtaining efficiency and information utilization of the user.

In some embodiments, for each display area in the virtual billboard, the display area displays at least one of the following: an appearance, an announced declaration, an avatar image, an account nickname, a live streaming image, and a challenge control of the first virtual object. Only after being authorized by the first virtual object, the appearance, the avatar image, the announced declaration, the account nickname, and the live streaming image can be broadcast to other virtual objects participating in the virtual battle.

The avatar image and the account nickname are an avatar image (that is, a game avatar) and an account nickname (that is, a game nickname) of a game account of the first virtual object in the game application, and therefore may be delivered by the game server.

The appearance may be an appearance preset by the first virtual object before starting the battle (for example, the preset appearance is presented when the first virtual object is displayed in the virtual billboard), or the appearance may be a current dressing appearance of the first virtual object in the virtual battle. This is not specifically limited in this embodiment of this application.

The announced declaration may be a declaration text preset by the first virtual object before starting the battle (for example, the preset announced declaration is presented when the first virtual object is displayed in the virtual billboard), or may be a personalized signature set by the first virtual object in the game application, or may be a declaration text preset by the game server according to a ranking of the first virtual object, or may be a declaration text inputted in real time in the game application when the first virtual object meets the announcement condition. This is not specifically limited in this embodiment of this application.

The live streaming image is a game image of the first virtual object in the virtual battle. For example, the live streaming image is a live streaming image in which the first virtual object is used as the first person, or a live streaming image in which the first virtual object is observed from the god viewing angle. The god viewing angle may be specified in game service logic. For example, the god viewing angle is a viewing angle of a virtual camera mounted at a fixed distance from the first virtual object. This is not specifically limited in this embodiment of this application. This can create a visual effect of game live streaming of the first virtual object in the virtual scene by using the virtual billboard.

The challenge control may be an interaction control displayed regardless of an announcement mode selected by the first virtual object, or may be an interaction control displayed only in a particular announcement mode. In operation 302, an example in which the challenge control is displayed only in the second announcement mode is used for description. Alternatively, the challenge control may be displayed in the display area for all the first virtual objects, but only the first virtual object enabling the second announcement mode can respond to a trigger operation performed on the challenge control. Display logic of the challenge control is not specifically limited in this embodiment of this application.

FIG. 4 is a schematic diagram of a virtual billboard according to an embodiment of this application. As shown in FIG. 4, for example, the announcement condition is a ranking condition in which a virtual object needs to be in a battle ranking list to be displayed in the virtual billboard. Assuming that the ranking condition is ranking in the first place in the battle ranking list, only one first virtual object ranking in the first place (also referred to as a player on top of the list) is displayed in the virtual billboard. In this case, a virtual billboard 410 is displayed in a virtual scene 400, a quantity of first virtual objects displayed in the virtual billboard 410 is 1, and for the only first virtual object, the entire virtual billboard 410 is a display area of the first virtual object, that is, the virtual billboard 410 has only one display area. Further, an appearance 411 and an announced declaration 412 “I am the strongest” of the first virtual object are displayed in the display area, that is, the virtual billboard 410. Further, current points (not shown in FIG. 4) of the first virtual object may further be displayed in the display area, to facilitate the user to calculate a point difference between the second virtual object and the first virtual object.

The first virtual object and the second virtual object are merely used for distinguishing a virtual object operated by a terminal and a virtual object displayed in the virtual billboard. However, the first virtual object and the second virtual object may be the same virtual object. For example, an appearance of the first virtual object can be naturally seen in the virtual billboard displayed on the terminal that operates the first virtual object. Certainly, the first virtual object and the second virtual object may alternatively be different virtual objects. This is not specifically limited in this embodiment of this application.

In some other embodiments, if there are a relatively large quantity of first virtual objects, but a display size of the virtual billboard is limited, the first virtual objects may be displayed in the virtual billboard in a scrolling manner (for example, displayed by scrolling upwards or downwards or scrolling leftwards or rightwards). In addition, the user may view a previous or a next first virtual object based on the scrolling operation of the virtual billboard or by clicking on a page flip button in the virtual billboard, thereby optimizing display logic of the virtual billboard.

302: The terminal further displays a challenge control for the first virtual object in the display area when the first virtual object enables a second announcement mode, where the challenge control is used to trigger a challenge operation performed on the first virtual object.

In some embodiments, the first virtual object may select an announcement mode enabled by the first virtual object for another virtual object (which may be a second virtual object or another different first virtual object) participating in the virtual battle. In different announcement modes, at least one of announcement information or interaction manners is different.

In this embodiment of this application, for example, there are two announcement modes. That is, the game service logic provides a first announcement mode and a second announcement mode. The first announcement mode is different from the second announcement mode. The second announcement mode is an announcement mode supporting a second virtual object to initiate a challenge against the first virtual object, and the first announcement mode is an announcement mode other than the second announcement mode.

In an example, the first announcement mode is used to announce a location of the first virtual object; and the second announcement mode is used to announce a location of the first virtual object and provide a navigation function for approaching the first virtual object. In this case, in the first announcement mode, only the location of the first virtual object is broadcast, and the second virtual object still needs to search for the first virtual object in the virtual scene before interacting with the first virtual object. Instead, interaction efficiency of the second announcement mode is higher. This is because in addition to broadcasting the location of the first virtual object, a direct challenge function based on the challenge control is further supported. In this case, the user can directly challenge the first virtual object through the challenge control, and then can directly airdrop or navigate to the location of the first virtual object by using the navigation function for approaching the first virtual object, and confront with the first virtual object. Therefore, the confrontation risk of the first virtual object is higher, but more points may be obtained to stabilize a ranking. The human computer interaction efficiency is higher.

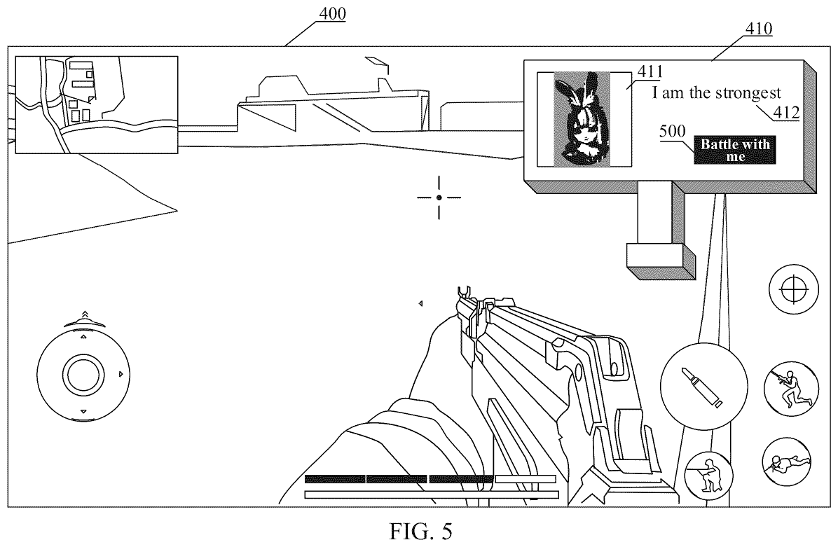

FIG. 5 is a schematic diagram of a virtual billboard according to an embodiment of this application. As shown in FIG. 5, for example, the announcement condition is a ranking condition in which a virtual object needs to be in a battle ranking list to be displayed in the virtual billboard. Assuming that the ranking condition is ranking in the first place in the battle ranking list, only one first virtual object ranking in the first place (also referred to as a player on top of the list) is displayed in the virtual billboard. In this case, a virtual billboard 410 is displayed in a virtual scene 400, a quantity of first virtual objects displayed in the virtual billboard 410 is 1, and for the only first virtual object, the entire virtual billboard 410 is a display area of the first virtual object, that is, the virtual billboard 410 has only one display area. Further, in the display area, that is, the virtual billboard 410, if the first virtual object enables the first announcement mode, an appearance 411 and an announced declaration 412 “I am the strongest” of the first virtual object are displayed in the virtual billboard 410, as shown in FIG. 4. If the first virtual object enables the second announcement mode, the appearance 411 and the announced declaration 412 “I am the strongest” of the first virtual object, and a challenge control 500 are displayed in the virtual billboard 410, as shown in FIG. 5.

As can be seen, a challenge declaration “battle with me” may be displayed on the challenge control 500. The challenge declaration may be a declaration text preset in the game service logic, or may be a declaration text customized by the first virtual object. The first virtual object may preset a customized declaration text before starting the battle, or may input a customized declaration text in real time when the announcement condition is met. This is not specifically limited in this embodiment of this application. The challenge declaration displayed on the challenge control 500 increases an information amount carried by the virtual billboard and improves a degree of display freedom of the challenge control.

In some other embodiments, the game service logic may further provide three or more announcement modes. The location of the first virtual object is announced (that is, announcement information includes the location of the first virtual object) in both the first announcement mode and the second announcement mode, but interaction manners are different in different announcement modes. In some embodiments, the game service logic may further classify multi-level announcement modes according to different announcement information, for example, an appearance announcement mode, a declaration announcement mode, a live streaming announcement mode, and a location announcement mode. Only an appearance of the first virtual object is announced in the appearance announcement mode. The appearance and an announced declaration of the first virtual object are announced in the declaration announcement mode. The appearance, the announced declaration, and a live streaming image of the first virtual object are announced in the live streaming announcement mode. The appearance, the announced declaration, and the location of the first virtual object are announced in the location announcement mode. In this way, the user may select a desired announcement mode according to a battle requirement and a privacy requirement of the user, and more personalized options are provided. For another example, the location announcement mode may further be divided into the first announcement mode and the second announcement mode in this embodiment of this application. In this way, more multi-level announcement modes are provided. The announcement mode may be set by the first virtual object before the battle, or may be set by the first virtual object instantly when the first virtual object meets the announcement condition. This is not specifically limited in this embodiment of this application.

Two or more announcement modes are provided above. In some other embodiments, certainly, only one announcement mode may also be provided in the game service logic. In this case, the first virtual object does not need to select an announcement mode to be enabled. A quantity of provided announcement modes is not specifically limited in the embodiments of this application.

In operations 301 and 302, any first virtual object displayed in the virtual billboard is described by using the first announcement mode and the second announcement mode as an example. When the first virtual object enables the first announcement mode, only operation 301 is performed to display the first virtual object in the display area. When the first virtual object enables the second announcement mode, in addition to performing operation 301 to display the first virtual object in the display area, operation 302 is further performed to display the challenge control for the first virtual object in the display area. In this way, the virtual billboard actually displays all first virtual objects enabling the first announcement mode, all first virtual objects enabling the second announcement mode, and challenge controls for all the first virtual objects enabling the second announcement mode. Because a challenge control is not provided for the first virtual object in the first announcement mode, redundant processing logic caused by an accidental trigger by the user is avoided, thereby saving computing resources of the terminal. In addition, because the challenge control is displayed for only the first virtual object enabling the second announcement mode, it is convenient for the user to observe the virtual billboard to clearly know first virtual objects that may be directly challenged and first virtual objects that can be only manually searched for, thereby improving information utilization of the user.

In some other embodiments, regardless of whether the first virtual object enables the first announcement mode or the second announcement mode, the challenge control for the first virtual object is displayed in the display area. In this way, each first virtual object and a challenge control for the first virtual object are displayed in the virtual billboard. However, the challenge control for the first virtual object in the first announcement mode may be set to a disabled status (there is no response to clicking or shooting), and the challenge control for the first virtual object in the second announcement mode may be set to an enabled status (there is response to clicking or shooting). Therefore, even if a user accidentally touches the challenge control for the first virtual object in the first announcement mode, it is not considered that a challenge operation on the first virtual object is detected. Therefore, a challenge initiated based on the challenge control is not received in the first announcement mode. In addition, advantages thereof are as follows: if the first virtual object switches from the first announcement mode to the second announcement mode, a challenge control does not abruptly appear on the virtual billboard, and instead an existing challenge control only needs to be switched from the disabled status to the enabled status, thereby optimizing display logic when the announcement mode is switched, avoiding disturbance to the virtual battle of a user, and ensuring immersive experience and game vibe of the user.

303: The terminal displays a query control in response to a trigger operation on the challenge control in the display area, where the query control is used to query whether to approach the first virtual object.

In some embodiments, for a first virtual object enabling the second announcement mode, the user may trigger a challenge operation on the first virtual object based on the challenge control provided in the corresponding display area of the virtual billboard in operation 302.

In operation 303, a possible implementation of displaying the query control in response to the challenge operation on any first virtual object is provided. In this case, the challenge operation includes: a trigger operation performed on the challenge control in the display area, that is, when the first virtual object enables the second announcement mode, the query control is displayed in response to the trigger operation performed on the challenge control in the display area. In other words, the user can trigger the challenge operation by performing a trigger operation on the challenge control for the first virtual object, so that the terminal pops up the query control. The challenge operation is initiated by using the challenge control, so that the user can trigger to challenge a first virtual object with one click based on the challenge control, thereby providing an intuitive, quick, and efficient interaction manner with a high-ranking virtual object.

In some embodiments, the trigger operation performed on the challenge control includes but is not limited to: a shooting operation, a click operation, a double click operation, a long-press operation, a sliding operation, a drag operation, a voice instruction, a gesture instruction, and the like performed by the second virtual object under control. This is not specifically limited in this embodiment of this application.

In an example, the trigger operation performed on the challenge control includes a shooting operation performed by the second virtual object under control. When the second virtual object is equipped with a shooting prop, a shooting control (for example, a firing key) for the shooting prop is further provided in the virtual scene, so that the user can trigger, based on the shooting control, the shooting operation performed by the second virtual object on the challenge control. Then, whether the shooting operation hits the challenge control is determined in response to the shooting operation performed by the second virtual object on the challenge control. When the shooting operation hits the challenge control, for example, the shooting operation hits any location of the challenge control, the query control is displayed. Otherwise, when the shooting operation does not hit the challenge control, there is no user interface (UI) response. In the foregoing process, only when the user controls the second virtual object to hit the challenge control, it is considered that the trigger operation performed on the challenge control is detected, that is, the challenge operation performed by the second virtual object on the first virtual object is detected. In this case, the query control pops up. In this triggering manner based on the shooting operation, the user needs to control the second virtual object to aim at the challenge control in the virtual billboard, and this aiming process represents that the user has subjective intention of challenging the first virtual object. Therefore, a probability that the user accidentally triggers the challenge operation is greatly reduced, and the entire challenge link requires the user to confirm for the second time through aiming, reducing an accidental trigger rate of the challenge operation.

The shooting operation performed by the second virtual object on the challenge control may be in a hip shooting mode (shooting without turning on a sight, that is, shooting directly without turning on an aiming sight) and an aiming down sight (ADS) (that is, turn on the aiming sight and adjust a front sight before shooting) mode. The shooting mode is not specifically limited in this embodiment of this application.

After the user hits the challenge control, some special spark effects generated after a shooting item of the shooting prop hits the challenge control may be further played, so that an entire challenge procedure based on the shooting operation better integrates with the virtual scene, thereby improving immersive game experience of the user.

Only the second virtual object equipped with the shooting prop is used as an example for description above. If the second virtual object is not equipped with the shooting prop, for example, the second virtual object is equipped with a throwing prop, the trigger operation on the challenge control may further include a throwing operation performed by the second virtual object under control. In this case, a throwing control for the throwing prop is further provided in the virtual scene. The user can trigger, based on the throwing control, the throwing operation performed by the second virtual object on the challenge control. Then, whether the throwing operation hits the challenge control is determined in response to the throwing operation performed by the second virtual object on the challenge control. When the throwing operation hits the challenge control, the query control is displayed. Otherwise, when the throwing operation does not hit the challenge control, there is no UI response. For another example, the second virtual object is equipped with a confrontation prop (for example, a virtual dagger). In this case, the trigger operation on the challenge control may be configured as a confrontation operation of holding the confrontation prop. This is not specifically limited herein.

In another example, if the second virtual object is not equipped with any virtual prop, the user may further trigger a trigger operation on the challenge control by clicking, double-clicking, or long-pressing the challenge control for the first virtual object displayed in the virtual billboard, or trigger a trigger operation on the challenge control by using a voice instruction or a gesture instruction. In this way, a human computer interaction link through which the user initiates the challenge operation is simpler, the challenge control does not need to be aimed at, and aiming performance of the user does not need to be considered, thereby reducing an operating threshold for initiating the challenge by the user, improving a success rate of initiating the challenge by the user, and improving human computer interaction efficiency.

In another example, the challenge control is not necessarily always provided in the display area, and may alternatively be displayed when triggered by specific display logic. For example, the user may further control the second virtual object to approach the virtual billboard. When the second virtual object approaches the virtual billboard to a specific degree (for example, a distance is less than a specified value or the second virtual object touches a collision detection box of the virtual billboard), a challenge control for a first virtual object in the closest display area is displayed. In this case, the user clicks, double-clicks, or long-presses the displayed challenge control, and it may be considered that a trigger operation on the challenge control is detected, that is, a challenge operation performed by the second virtual object on the first virtual object is detected. In this case, the query control pops up. In this way, the challenge control pops up only when the user approaches the virtual billboard, and the query control pops up only when the trigger operation is performed on the challenge control. Therefore, display logic of both the challenge control and the query control is optimized. On one hand, this avoids occupying screen space when the challenge control is always displayed in the virtual scene, and on the other hand, this also avoids an accidental trigger risk caused by displaying the challenge control for a long time.

After the user clicks, double-clicks, or long-presses the displayed challenge control, some animation effects generated after the second virtual object removes a virtual sticker that hides the appearance of the first virtual object in the virtual billboard may further be played, so that the entire challenge procedure better integrates with the virtual scene, thereby improving immersive game experience of the user.

In some other embodiments, in addition to the challenge operation shown in operation 303, the user can also trigger the challenge operation in the following manner: When the first virtual object enables the second announcement mode, the query control is displayed in response to a trigger operation on the display area. In other words, the user can trigger the challenge operation by performing a trigger operation on the entire display area, so that the terminal pops up the query control. The challenge operation is initiated by using the challenge control, so that the user can trigger to challenge a first virtual object with one click based on the display area, thereby providing an intuitive, quick, and efficient interaction manner with a high-ranking virtual object. In addition, compared with the trigger operation based on the challenge control, the entire display area may be considered as an implicit and interactive challenge control. Because the challenge control becomes hidden, but still does not affect an interaction function of triggering the challenge operation, display of the virtual billboard is simpler and better integrates with the virtual scene, and display logic of the virtual billboard is optimized.

In some embodiments, the trigger operation performed on the display area includes but is not limited to: a shooting operation, a click operation, a double click operation, a long-press operation, a sliding operation, a drag operation, a voice instruction, a gesture instruction, and the like performed by the second virtual object under control. This is not specifically limited in this embodiment of this application.

In an example, the trigger operation performed on the display area includes a shooting operation performed by the second virtual object under control. When the second virtual object is equipped with a shooting prop, a shooting control (for example, a firing key) for the shooting prop is further provided in the virtual scene, so that the user can trigger, based on the shooting control, the shooting operation performed by the second virtual object on the display area. Then, whether the shooting operation hits the display area is determined in response to the shooting operation performed by the second virtual object on the display area. When the shooting operation hits the display area, for example, the shooting operation hits any location of the display area, the query control is displayed. Otherwise, when the shooting operation does not hit the display area, there is no UI response. In the foregoing process, only when the user controls the second virtual object to hit the display area, it is considered that the trigger operation performed on the display area is detected, that is, the challenge operation performed by the second virtual object on the first virtual object is detected. In this case, the query control pops up. In this triggering manner based on the shooting operation, the user needs to control the second virtual object to aim at the display area in the virtual billboard, and this aiming process represents that the user has subjective intention of challenging the first virtual object. Therefore, a probability that the user accidentally triggers the challenge operation is greatly reduced, and the entire challenge link requires the user to confirm for the second time through aiming, reducing an accidental trigger rate of the challenge operation.

The shooting operation performed by the second virtual object on the display area may be in a hip shooting mode (shooting without turning on a sight, that is, shooting directly without turning on an aiming sight) and an aiming down sight (ADS) (that is, turn on the aiming sight and adjust a front sight before shooting) mode. The shooting mode is not specifically limited in this embodiment of this application.

After the user hits the display area, some special spark effects generated after a shooting item of the shooting prop hits the display area may be further played, so that an entire challenge procedure based on the shooting operation better integrates with the virtual scene, thereby improving immersive game experience of the user.

Only the second virtual object equipped with the shooting prop is used as an example for description above. If the second virtual object is not equipped with the shooting prop, for example, the second virtual object is equipped with a throwing prop, the trigger operation on the display area may further include a throwing operation performed by the second virtual object under control. In this case, a throwing control for the throwing prop is further provided in the virtual scene. The user can trigger, based on the throwing control, the throwing operation performed by the second virtual object on the display area. Then, whether the throwing operation hits the display area is determined in response to the throwing operation performed by the second virtual object on the display area. When the throwing operation hits the display area, the query control is displayed. Otherwise, when the throwing operation does not hit the display area, there is no UI response. For another example, the second virtual object is equipped with a confrontation prop (for example, a virtual dagger). In this case, the trigger operation on the display area may be configured as a confrontation operation of holding the confrontation prop. This is not specifically limited herein.

In another example, if the second virtual object is not equipped with any virtual prop, the user may further trigger a trigger operation on the display area by clicking, double-clicking, or long-pressing the display area for displaying the first virtual object in the virtual billboard, or trigger a trigger operation on the display area by using a voice instruction or a gesture instruction. In this way, a human computer interaction link through which the user initiates the challenge operation is simpler, the display area does not need to be aimed at, and aiming performance of the user does not need to be considered, thereby reducing an operating threshold for initiating the challenge by the user, improving a success rate of initiating the challenge by the user, and improving human computer interaction efficiency.

After the user clicks, double-clicks, or long-presses the display area, some animation effects generated after the second virtual object removes a virtual sticker that hides the appearance of the first virtual object in the virtual billboard may further be played, so that the entire challenge procedure better integrates with the virtual scene, thereby improving immersive game experience of the user.

In another example, when all teammates of a team are displayed in the same display area of the virtual billboard, if many teammates in the team are not eliminated, providing one challenge control for each teammate in the display area may increase information density of the virtual billboard. Therefore, in this case, an appearance of each teammate, that is, each first virtual object, is used as an implicit challenge control, and the user may directly click, double-click, or long-press an appearance of a teammate to pop up the query control.

In the foregoing process, regardless of how the user triggers the trigger operation on the challenge control or the display area, a query control pops up, and the user may further determine, by using the query control, whether to approach the first virtual object. This effectively avoids moving close to a first virtual object due to accidental trigger of the virtual billboard by the user, thereby reducing an accidental trigger rate of the user. Certainly, alternatively, after the trigger operation on the challenge control is detected, the second virtual object may be directly controlled to move towards the first virtual object, thereby shortening a confrontation operation link between the second virtual object and the first virtual object, and improving human computer interaction efficiency.

In some other embodiments, the foregoing provides a triggering manner of the challenge operation on the first virtual object based on the display area of the first virtual object or based on the challenge control in the display area. In some embodiments, alternatively, the user may perform a triggering operation on the entire virtual billboard, then a virtual object selection pop-up window pops up, all selectable first virtual objects are displayed in the virtual object selection pop-up window, and then the user selects a target first virtual object in the virtual object selection pop-up window, to initiate a challenge operation on the first virtual object. A triggering procedure of the challenge operation is not specifically limited in this embodiment of this application.

How to trigger display of the query control is described in detail in the above cases. A display manner of the query control is described in detail below. In some embodiments, the query control directly pops up in the virtual scene on the terminal, or the query control is displayed based on the virtual billboard. A display location of the query control is not specifically limited in this embodiment of this application.

In some embodiments, the terminal may display the query control in a form of query pop-up window, that is, the terminal displays a query pop-up window in the virtual scene. The query pop-up window provides a confirmation option and a cancellation option. When the user performs a triggering operation on the confirmation option, it is considered as a confirmation operation on the query control, and operation 304 is performed. When the user performs a triggering operation on the cancellation option, or performs no operation within a specified time period, it is considered as a cancellation operation on the query control. In this case, the query pop-up window is folded into a brief query control, which facilitates the user to click on the query control to unfold the query pop-up window again. In this way, the display is more intuitive, and an interaction manner of querying through a pop-up window relatively conforms to usage habit of the user.

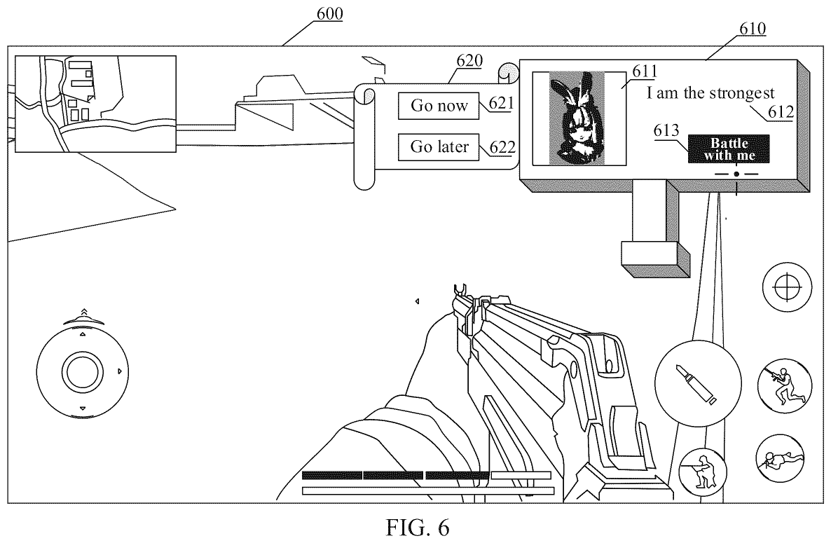

FIG. 6 is a schematic diagram of a query control according to an embodiment of this application. As shown in FIG. 6, for example, the announcement condition is a ranking condition in which a virtual object needs to be in a battle ranking list to be displayed in the virtual billboard. Assuming that the ranking condition is ranking in the first place in the battle ranking list, only one first virtual object ranking in the first place (also referred to as a player on top of the list) is displayed in the virtual billboard. In this case, a virtual billboard 610 is displayed in a virtual scene 600. If the first virtual object enables the second announcement mode, an appearance 611 and an announced declaration 612 “I am the strongest” of the first virtual object, and a challenge control 613 are displayed in the virtual billboard 610. A challenge declaration “battle with me” of the first virtual object is displayed on the challenge control 613. The user may operate the second virtual object to shoot the challenge control 613 (or shoot the entire virtual billboard 610), to initiate a challenge operation on the first virtual object. In response to the challenge operation performed by the second virtual object on the first virtual object, the terminal presents a query pop-up window 620 on the left side of the virtual billboard 610. The query pop-up window 620 is a possible implementation of the query control. The query pop-up window 620 provides a confirmation option 621 and a cancellation option 622. When the user performs a triggering operation on the confirmation option 621, it is considered as a confirmation operation on the query control, and operation 304 is performed. When the user performs a triggering operation on the cancellation option 622, or performs no operation within a specified time period, it is considered as a cancellation operation on the query control, and in this case, the query pop-up window 620 is folded into a brief query control.

In some other embodiments, when displaying the query control, the terminal may display the query control, the confirmation option, and the cancellation option. When the user performs a triggering operation on the confirmation option, it is considered as a confirmation operation on the query control, and operation 304 is performed. When the user performs a triggering operation on the cancellation option, or performs no operation within a specified time period, it is considered as a cancellation operation on the query control, and in this case, the confirmation option and the cancellation option are removed, and only the brief query control is reserved, which facilitates the user to click on the query control to display the confirmation option and the cancellation option again. In this way, no pop-up window is redundantly reserved, thereby reducing interface occupation of the virtual scene and optimizing interface display simplicity.

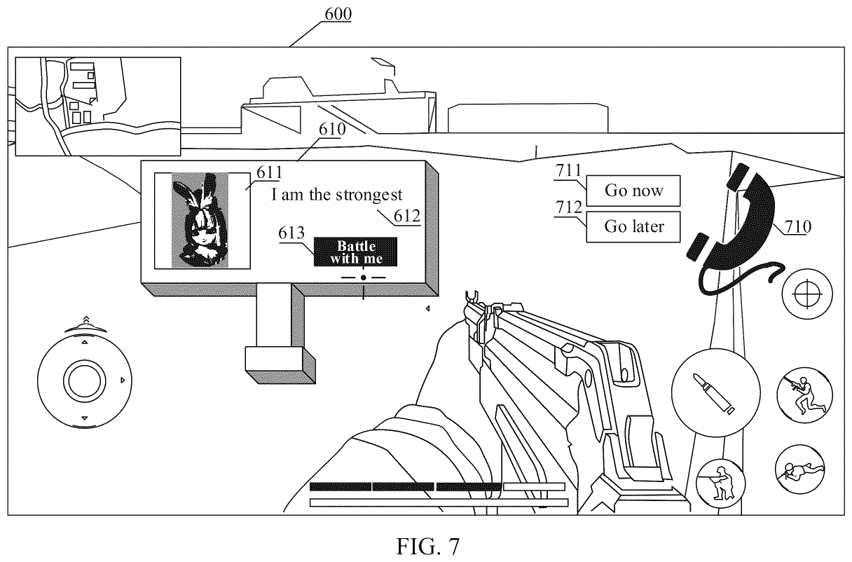

FIG. 7 is a schematic diagram of a query control according to an embodiment of this application. As shown in FIG. 7, for example, the announcement condition is a ranking condition in which a virtual object needs to be in a battle ranking list to be displayed in the virtual billboard. Assuming that the ranking condition is ranking in the first place in the battle ranking list, only one first virtual object ranking in the first place (also referred to as a player on top of the list) is displayed in the virtual billboard. In this case, a virtual billboard 610 is displayed in a virtual scene 600. If the first virtual object enables the second announcement mode, an appearance 611 and an announced declaration 612 “I am the strongest” of the first virtual object, and a challenge control 613 are displayed in the virtual billboard 610. A challenge declaration “battle with me” of the first virtual object is displayed on the challenge control 613. The user may operate the second virtual object to shoot the challenge control 613 (or shoot the entire virtual billboard 610), to initiate a challenge operation on the first virtual object. In response to the challenge operation performed by the second virtual object on the first virtual object, the terminal displays a query control 710, a confirmation option 711, and a cancellation option 712 in a virtual scene 600. When the user performs a triggering operation on the confirmation option 711, it is considered as a confirmation operation on the query control 710, and operation 304 is performed. When the user performs a triggering operation on the cancellation option 712, or performs no operation within a specified time period, it is considered as a cancellation operation on the query control 710, and in this case, the confirmation option 711 and the cancellation option 712 are removed, and only the brief query control 710 is reserved, which facilitates the user to click on the query control 710 to display the confirmation option 711 and the cancellation option 712 again. Herein, the query control 710 is shown only as a phone icon, so that an interaction manner in which the second virtual object calls the first virtual object for confrontation can be simulated, thereby improving immersive game experience of the user.

In some other embodiments, when displaying the query control, the terminal may not provide an explicit confirmation option and an explicit cancellation option. The user may trigger a confirmation operation by long-pressing the query control. If the user performs no operation on the query control, it is considered that the cancellation operation is performed. Then, operation 304 is performed in response to the confirmation operation. A size of the query control may be reduced or the query control may be directly hidden in response to the cancellation operation. This is not specifically limited herein.

304: The terminal controls, in response to a confirmation operation performed on the query control, the second virtual object to move towards the first virtual object.

In some embodiments, the user of the terminal may perform a confirmation operation or a cancellation operation on the query control popping up in operation 303. If the terminal detects that the user performs the confirmation operation on the query control, it indicates that the user confirms for the second time, and the second virtual object controlled by the terminal is controlled to move towards the first virtual object. If detecting that the user performs a cancellation operation on the query control, the terminal may fold the query control, so that the user can trigger or call the query control again when subsequently wanting to find the first virtual object. Certainly, the query control may alternatively be directly hidden, to avoid that the query control blocks the virtual scene. This is not specifically limited in this embodiment of this application.

In some embodiments, the terminal may control, in various manners, the second virtual object to move towards the first virtual object. Several typical control manners are used as examples for description below.

### Manner 1: Automatic Navigation

In some embodiments, the terminal controls, in response to a confirmation operation performed by the user on the query control, the second virtual object to move towards the first virtual object according to an automatic navigation route. In some embodiments, the terminal may determine, by using an A* pathfinding algorithm built in a game engine, an automatic navigation route that uses a location of the second virtual object as a start point and a location of the first virtual object as an end point, and control the second virtual object to move towards the first virtual object according to the automatic navigation route. Herein, only the A* pathfinding algorithm is used as an example. In some embodiments, the navigation route may also be determined by using the Dijkstra's algorithm or another pathfinding/navigation algorithm. This is not specifically limited in this embodiment of this application.

In some embodiments, the terminal may display or skip displaying the automatic navigation route in the virtual scene, and may also display or skip displaying the automatic navigation route in a small map control. This is not specifically limited in this embodiment of this application.

The foregoing automatic navigation manner provides a ground enemy positioning manner in which the second virtual object searches for the first virtual object, and is applicable to some game scenarios that do not support air interaction or do not support flying vehicles.

### Manner 2: Airdrop

In some embodiments, the terminal controls, in response to a confirmation operation performed by the user on the query control, the second virtual object to airdrop to a movement area or a preset range of the first virtual object.

The foregoing airdrop manner provides an air displacement manner in which the second virtual object searches for the first virtual object, and is applicable to some game scenarios that support air interaction or provide flying vehicles. The manner has a high flight speed and high enemy positioning efficiency. However, the airdrop manner generally can be enabled only when the second virtual object is equipped with or can use a flying vehicle. The flying vehicle includes but is not limited to: a virtual aircraft, a virtual parachute, a virtual hot balloon, a virtual airship, and the like. A type of the flying vehicle is not specifically limited herein.

In some embodiments, the terminal controls the second virtual object to move to a movement area of the first virtual object in the virtual scene, and identifies the location of the first virtual object in the movement area. This is equivalent to that the second virtual object is airdropped to a fuzzy range, that is, is merely airdropped to the movement area but does not position the first virtual object. In addition, to prompt the location of the first virtual object, the location of the first virtual object is identified in the movement area. In this way, a fast flight speed and high enemy positioning efficiency are ensured. Besides, the first virtual object is provided with a particular time for preparation and ambush, and the second virtual object is provided with strong prompt information, thereby improving confrontation and strategy nature of the game and improving efficiency of human computer interaction between virtual objects.

In some embodiments, the terminal controls the second virtual object to move to a preset range of the first virtual object. This is equivalent to that the second virtual object is precisely airdropped to a fixed point. Not only the second virtual object is airdropped to the movement area, but also a relatively precise preset range is positioned in the movement area. The preset range is specified in game service logic. For example, the preset range is a spherical space, a cubic space, or a three-dimensional space of another shape with the first virtual object as the center. This is not specifically limited herein. Because the second virtual object is airdropped to a fixed point in the preset range, a fast flight speed and high enemy positioning efficiency are ensured. Besides, the first virtual object is provided with a particular time for preparation and ambush, thereby improving confrontation and strategy nature of the game and improving efficiency of human computer interaction between virtual objects.

In some embodiments, in the process of airdropping the second virtual object to a preset range of the first virtual object, the terminal may perform: controlling the second virtual object to fly to an airdrop point of a preset altitude within the preset range; determining a landing direction that uses the airdrop point as a start point; determining a landing location of the second virtual object based on the airdrop point and the landing direction; and controlling the second virtual object to land to the landing location from the airdrop point.

In the foregoing process, the airdrop point of the preset altitude is determined within the preset range of the first virtual object. The airdrop point is any location of the preset altitude within the preset range. For example, the airdrop point is an intersection point of the preset altitude in an intersection line of a flight route and the preset range. Then, a landing direction that uses the airdrop point as a start point may be determined. For example, the landing direction may be a preset downward direction that is perpendicular to the ground, or the landing direction may be a user-defined direction, and in this case, the user may operate a joystick control in the location of the airdrop point, and then the terminal determines the landing direction according to a direction of sliding the joystick control by the user. Next, the landing location of the second virtual object is determined based on the airdrop point and the landing direction. That is, a ray can be determined according to the airdrop point and the landing direction, and an intersection point of the ray and the ground is used as the landing location, or an intersection point of the ray and the first obstacle (which may be a virtual object such as a roof, a wall, or a bunker) that is touched is used as the landing location. Logic for determining the landing location is not specifically limited in this embodiment of this application. Next, the second virtual object is controlled to land from the airdrop point to the landing location. For example, the second virtual object is controlled to slowly land to the landing location on a flying vehicle, or the second virtual object is controlled to slowly land to the landing location after leaving a flying vehicle. Whether a landing process relies on the flying vehicle is not specifically limited in this embodiment of this application.

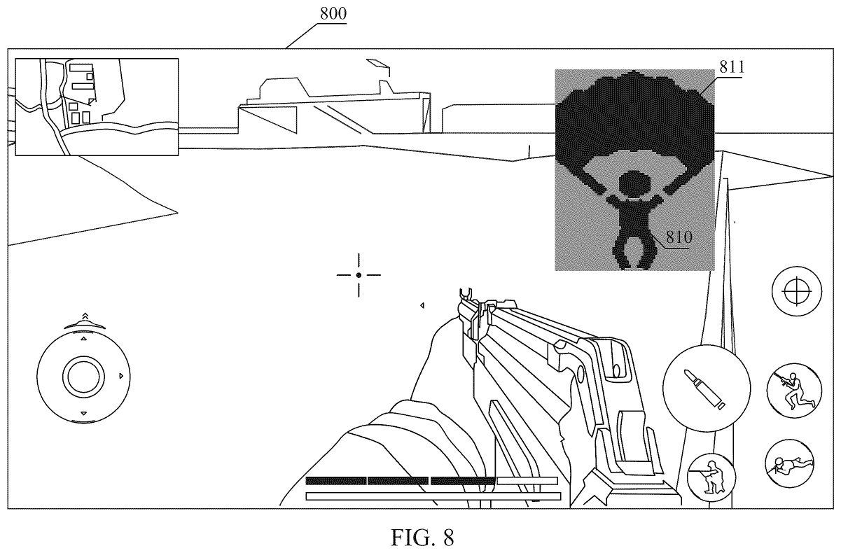

FIG. 8 is a schematic diagram of an interface of an airdrop manner according to an embodiment of this application. FIG. 8 shows a UI interface in which a second virtual object comes within a preset range observed from an FoV of a first virtual object, that is, a visual effect of the airdrop manner of the second virtual object is presented at a viewing angle of the first virtual object. A second virtual object 810 is displayed in a virtual scene 800. The second virtual object 810 is airdropped to a preset range of the first virtual object on a flying vehicle 811, so that the second virtual object 810 appears within the FoV of the first virtual object. Herein, only an example in which the flying vehicle 811 is a virtual parachute is used for description. In this case, the flying vehicle 811 brings the second virtual object 810 to an airdrop point of a preset altitude, and then the user may operate a landing direction of the second virtual object 810, to adjust a landing location of the second virtual object 810 in the virtual scene 800. In this way, after reaching the landing location, the second virtual object 810 can efficiently interact with the first virtual object.

In some embodiments, the terminal may display or skip displaying a flight route of the flying vehicle in the virtual scene, and may also display or skip displaying the flight route in a small map control. This is not specifically limited in this embodiment of this application.

In the movement manner of the two phases of airdrop and landing, many second virtual objects may all challenge the first virtual object at the same moment; therefore, many second virtual objects are airdropped to the preset range of the first virtual object. In this case, even if a plurality of second virtual objects are airdropped to the same airdrop point at the same moment, users may adjust landing directions to land in different landing locations, so that landing processes of the second virtual objects have higher controllability and degree of freedom. The second virtual object may adjust the landing direction and the landing location according to arrangement of a bunker within the preset range, so that the game is more strategic and interesting.

### Manner 3: Transfer

In some embodiments, the terminal controls, in response to a confirmation operation performed by the user on the query control, the second virtual object to be transferred to a preset range of the first virtual object. In some embodiments, the terminal randomly selects a reachable transfer location within the preset range, and controls the second virtual object to be directly transferred or flashed to the transfer location. Alternatively, the user selects a reachable transfer location within the preset range by using a small map control, and controls the second virtual object to be directly transferred or flashed to the transfer location. This is not specifically limited in this embodiment of this application.

The foregoing transfer manner provides a teleporting manner in which the second virtual object searches for the first virtual object, and is applicable to some game scenarios that support teleporting setting. For example, transfer can be enabled only when the second virtual object has a teleporting prop. In this way, interaction manners are diversified, and this helps the second virtual object quickly reach the location of the first virtual object, thereby achieving surprising confrontation and further improving human computer interaction efficiency.

305: In a case that a distance between the first virtual object and the second virtual object is less than a distance threshold, the terminal identifies the location of the first virtual object or highlights the first virtual object.

In some embodiments, as the second virtual object moves towards the first virtual object in operation 304, when a distance between the first virtual object and the second virtual object is less than a distance threshold, the location of the first virtual object may be directly identified in the virtual scene, or the first virtual object may be highlighted in the virtual scene. The distance threshold is specified in game service logic, and the distance threshold may be any value greater than 0. In this way, regardless whether the location is identified or highlighted, the current location of the first virtual object can be intuitively presented to the second virtual object. This helps the second virtual object quickly position the enemy to find the first virtual object, and directly confront the first virtual object. In addition, a triggering logic of identifying or highlighting the location depends on a distance between the first virtual object and the second virtual object. In this way, whether the first virtual object is located inside a bunker or hidden behind a bunker is ignored, and the second virtual object can quickly find the current location of the first virtual object, thereby further improving the human computer interaction efficiency of the user.

In some other embodiments, the location of the first virtual object may be directly identified in the virtual scene, or the first virtual object may be highlighted in the virtual scene only when the distance between the first virtual object and the second virtual object is less than the distance threshold and the first virtual object is visible. In this way, even if the second virtual object and the first virtual object are very close to each other, if the first virtual object finds a suitable bunker, the first virtual object may still hide. This improves room for maneuver of the first virtual object and reserves operational flexibility to some extent, so that playing strategies are more diversified. In addition, strategies may be developed depending on terrains or facilities of the virtual scene, thereby further improving immersive experience of the user.

In some embodiments, when identifying the location of the first virtual object in the virtual scene, the terminal may directly display, in the virtual scene, a buoy that follows the first virtual object. The buoy can penetrate through a bunker. Alternatively, the terminal may directly identify the location of the first virtual object in a small map control by using a specified graphic. For example, the specified graphic is a red dot or may be a dot of another color, but is not limited to a dot and may be a star. The buoy directly marks the location of the first virtual object in the virtual scene, and the specified graphic marks the location of the first virtual object in the small map control. One may be selected to mark, or both may be selected to mark. The user may select a specific marking manner. This is not specifically limited in this embodiment of this application.

In some embodiments, the distance between the first virtual object and the second virtual object may be additionally prompted in the virtual scene, for example, “XX meters away from the target”. The prompt may be displayed in the virtual scene, or may be dynamically displayed based on the buoy, or may be displayed based on a small map control. This is not specifically limited in this embodiment of this application.

In some embodiments, the user may trigger calculation of an automatic navigation route from the second virtual object to the first virtual object by clicking on the buoy or the specified graphic of the small map control, and display the automatic navigation route in at least one of the virtual scene or the small map control, to help the user rapidly follow the automatic navigation route to find the first virtual object. Certainly, a following operation may be manually controlled by the user, or may be trusted by the user to game service logic for automatic navigation. This is not specifically limited in this embodiment of this application.

In some embodiments, when highlighting the first virtual object in the virtual scene, the terminal may display an exclusive special mark effect based on the first virtual object, so that the special mark effect moves with the first virtual object. For example, the special mark effect may be a special light column effect appearing on top of the head, or certainly may be a special effect in another display manner, such as a special cloud effect or a special spherical effect. This is not specifically limited in this embodiment of this application. Alternatively, a special tick effect may be added to the full-body model of the first virtual object, or the full-body model of the first virtual object may be highlighted. In this way, a difference between the first virtual object and another virtual object can be highlighted. However, a special effect that occupies an extra image and covers the screen does not need to be added, so that the virtual scene is more user-friendly.

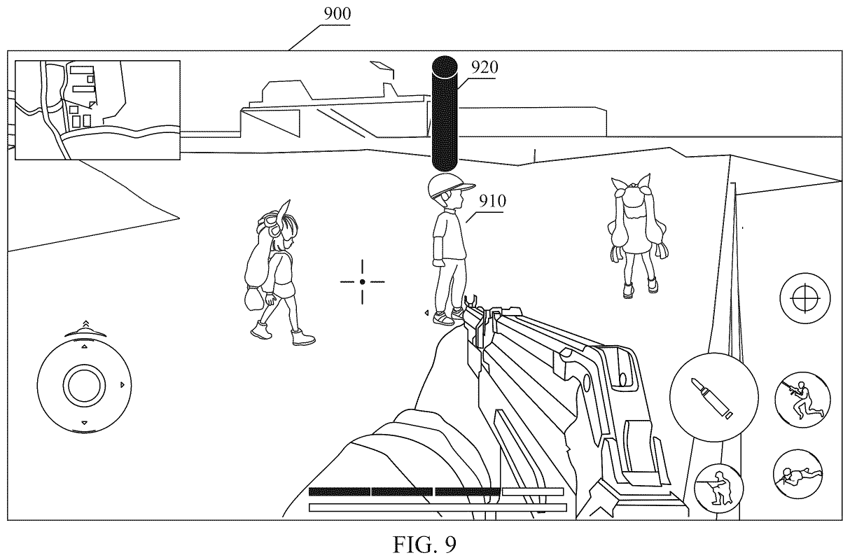

FIG. 9 is a schematic diagram of a special effect of marking a first virtual object according to an embodiment of this application. FIG. 9 shows a UI interface in which a distance between a first virtual object and a second virtual object is less than a distance threshold observed from an FoV of the second virtual object, that is, how to highlight the first virtual object is presented at a viewing angle of the second virtual object. A first virtual object 910 and two remaining first virtual objects that do not meet an announcement condition are displayed in a virtual scene 900. In this case, a special mark effect 920 is displayed on top of the head of the first virtual object 910. Herein, for example, the special mark effect 920 is a special light column effect. However, the special mark effect 920 may be implemented as a special cloud effect or a special spherical effect. This is not specifically limited in this embodiment of this application. In this way, the special mark effect 920 can intuitively prompt a virtual object that is a target first virtual object, thereby facilitating rapid enemy positioning and interaction initiation and further improving user interaction efficiency. In some embodiments, the special mark effect 920 keeps moving with the first virtual object 910, unless the first virtual object 910 is eliminated or the first virtual object 910 no longer meets an announcement condition (for example, a ranking in a battle ranking list decreases).

Operations 301 to 305 show how the second virtual object initiates, at a moment, a challenge against a first virtual object that enables the second announcement mode. However, as the virtual battle progresses, the first virtual object that meets the announcement condition may be updated or refreshed in real time. For example, the first virtual object may no longer meet the announcement condition at a moment due to a change in a ranking, or the first virtual object may be eliminated and therefore no longer meets the announcement condition at a moment. Therefore, the first virtual object displayed in the virtual billboard is also updated or refreshed in real time. Display logic and interaction logic before and after refreshing are similar, and details are not described again.

Any combination of the foregoing technical solutions may be used to obtain an embodiment of the present disclosure. Details are not described herein.

In the method provided in the embodiments of this application, the virtual billboard set in the virtual scene highlights and prompts the first virtual object meeting the announcement condition, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. That is, the user can initiate the challenge operation on the displayed first virtual object directly based on the virtual billboard, to automatically and directly move, after re-confirmation through the query control, towards the first virtual object to be challenged, and rapidly position and pursue the first virtual object to enable efficient interaction between the virtual objects. First virtual objects do not need to be searched for one by one in the virtual scene, and instead the first virtual object can be quickly positioned based on the announcement of the virtual billboard, thereby improving human computer interaction efficiency.

When the announcement condition is related to a ranking in the battle ranking list, the virtual billboard set in the virtual scene is used to highlight and prompt the first virtual object whose ranking meets the announcement condition in the battle ranking list, to prevent the user from ignoring information provided by the battle ranking list, thereby improving ranking list information utilization and information obtaining efficiency of the user. Because the virtual billboard is set in the virtual scene and integrates well with terrains or facilities of the virtual scene, abrupt display of the first virtual object is avoided, thereby ensuring immersive game experience of the user.

In the foregoing embodiment, how the second virtual object initiates a challenge against a first virtual object enabling the second announcement mode is described in detail. In the embodiments of this application, how the first virtual object selects the announcement mode is described in detail.

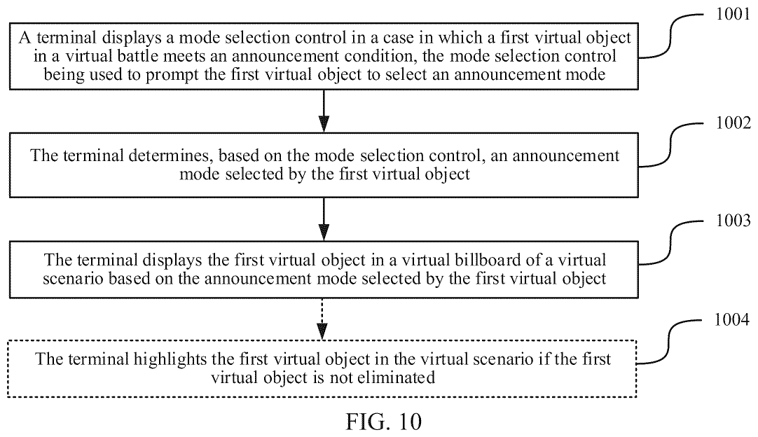

FIG. 10 is a flowchart of an interaction method based on a virtual billboard according to an embodiment of this application. Referring to FIG. 10, this embodiment is performed by an electronic device. The electronic device is a terminal that operates a first virtual object. For example, the terminal may be provided as the first terminal 120 or the second terminal 160 in the foregoing implementation environment. This embodiment includes the following operations:

1001: A terminal displays a mode selection control in a case in which a first virtual object in a virtual battle meets an announcement condition, the mode selection control being used to prompt the first virtual object to select an announcement mode.

A manner of determining the announcement condition and the first virtual object is the same as that in operation 301 in the foregoing embodiment, and details are not described again. The terminal herein is a terminal that operates the first virtual object.

In some embodiments, when a virtual object controlled by the terminal meets the announcement condition in the virtual battle, it indicates that the virtual object currently controlled by the terminal is a first virtual object. Therefore, the terminal may display a mode selection control in the virtual scene. The mode selection control is used to prompt the first virtual object to select an announcement mode, so that a user quickly determines and selects an announcement mode to be enabled.

In some embodiments, for each first virtual object that meets the announcement condition in the virtual battle, a server delivers a display resource of the mode selection control to a terminal that controls the first virtual object, and the terminal displays the mode selection control according to the display resource. Alternatively, when a terminal of each first virtual object detects that the first virtual object meets the announcement condition in the virtual battle, the terminal loads and displays the mode selection control from a cache, or obtains the mode selection control from the server.

In this embodiment of this application, only an example in which game service logic provides two or more announcement modes and a user may autonomously determine to select one of the announcement modes in real time is used for description. In different announcement modes, at least one of announcement information or interaction manners is different. If the game service logic provides only one announcement mode, a user does not need to select the announcement mode.

In some embodiments, for example, the game service logic provides two announcement modes. That is, the game service logic provides a first announcement mode and a second announcement mode. The first announcement mode is different from the second announcement mode. The second announcement mode is an announcement mode supporting a second virtual object to initiate a challenge against the first virtual object, and the first announcement mode is an announcement mode other than the second announcement mode.

In this case, the mode selection control may include a mode selection pop-up window, and the first announcement mode and the second announcement mode are displayed in the mode selection pop-up window. In this way, the pop-up window is used to prompt a user to select an announcement mode, and all selectable announcement modes are displayed in the mode selection pop-up window, so that the user can personally select a to-be-enabled announcement mode, thereby improving mode selection efficiency.

In an example, the first announcement mode is used to announce a location of the first virtual object; and the second announcement mode is used to announce a location of the first virtual object and provide a navigation function for approaching the first virtual object. In this case, in the first announcement mode, only the location of the first virtual object is broadcast, and the second virtual object still needs to search for the first virtual object in the virtual scene before interacting with the first virtual object. Instead, interaction efficiency of the second announcement mode is higher. This is because in addition to broadcasting the location of the first virtual object, a navigation function for approaching the first virtual object is further supported. In this case, the user can directly airdrop or navigate to the location of the first virtual object by using the navigation function, and confront with the first virtual object. Therefore, the confrontation risk of the first virtual object is higher, but more points may be obtained to stabilize a ranking. The human computer interaction efficiency is higher.

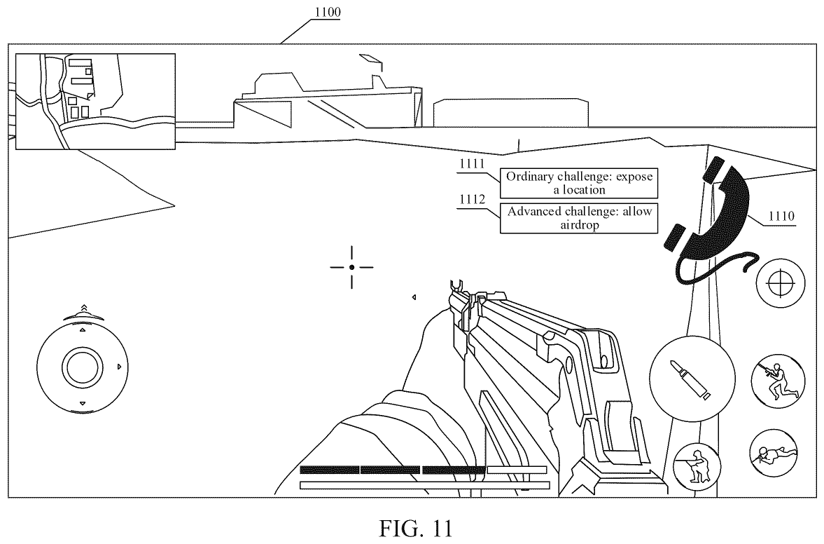

FIG. 11 is a schematic diagram of a mode selection control according to an embodiment of this application. As shown in FIG. 11, when the first virtual object meets the announcement condition in the virtual battle, a mode selection control 1110 is displayed in a virtual scene 1100. For example, the mode selection control is a mode selection pop-up window. A first announcement mode 1111 and a second announcement mode 1112 are displayed in the mode selection pop-up window. It prompts description information “ordinary challenge: expose a location” in the first announcement mode 1111, and description information “advanced challenge: allow airdrop” in the second announcement mode 1112. It is convenient for a user to quickly identify differences between different announcement modes based on the description information. The user may perform a trigger operation on any announcement mode provided in the mode selection pop-up window, to select a to-be-enabled announcement mode. In some embodiments, if the user does not select an announcement mode within a timeout period, the user may select the first announcement mode 1111 by default, or select the second announcement mode 1112 by default. An announcement mode selected by default may be preconfigured by the user before starting the battle, or configured in game service logic. This is not specifically limited in this embodiment of this application. Herein, only an example in which the mode selection control 1110 presents as a phone icon is used for description. Receiving an incoming call by the first virtual object can be simulated, to create a display effect of calling to query an announcement mode to be selected, thereby improving immersive experience of the user.

In some other embodiments, the game service logic may further provide three or more announcement modes. The location of the first virtual object is announced (that is, announcement information includes the location of the first virtual object) in both the first announcement mode and the second announcement mode, but interaction manners are different in different announcement modes. In some embodiments, the game service logic may further classify multi-level announcement modes according to different announcement information, for example, an appearance announcement mode, a declaration announcement mode, a live streaming announcement mode, and a location announcement mode. Only an appearance of the first virtual object is announced in the appearance announcement mode. The appearance and an announced declaration of the first virtual object are announced in the declaration announcement mode. The appearance, the announced declaration, and a live streaming image of the first virtual object are announced in the live streaming announcement mode. The appearance, the announced declaration, and the location of the first virtual object are announced in the location announcement mode. In this way, the user may select a desired announcement mode according to a battle requirement and a privacy requirement of the user, and more personalized options are provided. For another example, the location announcement mode may further be divided into the first announcement mode and the second announcement mode in this embodiment of this application. In this way, more multi-level announcement modes are provided. The announcement mode may be set by the first virtual object before the battle, or may be set by the first virtual object instantly when the first virtual object meets the announcement condition. This is not specifically limited in this embodiment of this application.

In this case, all selectable announcement modes may be displayed in the mode selection pop-up window, for example, the appearance announcement mode, the declaration announcement mode, the live streaming announcement mode, and the location announcement mode are displayed. After the user selects the location announcement mode, the first announcement mode and the second announcement mode further pop up, so that the user further makes decision. In this way, it is convenient for the user to customize announced information and a supported interaction manner, thereby improving mode selection efficiency.

In some embodiments, if the user configures a default or preferential announcement mode before the battle, when displaying the mode selection pop-up window, the configured default or preferential announcement mode may be displayed on top or highlighted. For example, the default or preferential announcement mode is placed on the first row, or the default or preferential announcement mode is highlighted, or an identification word such as “(default)” or “(recommended)” is added to the default or preferential announcement mode. This is not specifically limited in this embodiment of this application.

1002: The terminal determines, based on the mode selection control, an announcement mode selected by the first virtual object.

In some embodiments, the terminal may select one to-be-enabled announcement mode from a plurality of announcement modes based on the mode selection control displayed in operation 1001. For example, when the mode selection control is implemented as a mode selection pop-up window, the user may perform a selection operation on any announcement mode provided in the mode selection pop-up window, to determine the announcement mode selected by the selection operation. In some embodiments, the selection operation includes but is not limited to: a click operation, a double click operation, a long-press operation, a sliding operation, a drag operation, a voice instruction, a gesture instruction, and the like. This is not specifically limited in this embodiment of this application. FIG. 11 is still used as an example for description. The user may click on the first announcement mode 1111, to select the first announcement mode to announce only the location but not support airdrop. Alternatively, the user may click on the second announcement mode 1112, to select the second announcement mode to announce the location and support airdrop.

1003: The terminal displays the first virtual object in a virtual billboard of a virtual scene based on the announcement mode selected by the first virtual object.

In some embodiments, the virtual billboard includes at least one display area, and each display area is used to display one target first virtual object. In this case, the terminal may determine a display area of the first virtual object in the virtual billboard. In some embodiments, the terminal determines, according to a ranking of the first virtual object (or a team of the first virtual object) in the battle ranking list, a display area matching the rank.

The terminal displays the first virtual object in the display area when the first virtual object enables the first announcement mode; or displays the first virtual object and a challenge control for the first virtual object in the display area when the first virtual object enables the second announcement mode, where the challenge control is used to trigger the challenge operation performed on the first virtual object. For display logic of the display area in the first announcement mode and the second announcement mode, refer to operations 301 and 302 in the foregoing embodiment, and details are not described again.

In some embodiments, the display area displays at least one of the following: an appearance, an announced declaration, an avatar image, an account nickname, a live streaming image, and a challenge control of the first virtual object. For display logic of each piece of information in the display area, refer to operations 301 and 302 in the foregoing embodiment, and details are not described again.

1004: The terminal highlights the first virtual object in the virtual scene when the first virtual object is not eliminated.

In some embodiments, when the first virtual object of the terminal has been eliminated, the user may watch a battle at a viewing angle of a teammate, or is prompted to exit this battle. However, when the first virtual object is not eliminated, the terminal may highlight the first virtual object in the virtual scene. For a highlighting manner, refer to operation 305 in the foregoing embodiment, and details are not described again. This highlighting manner also helps the user to intuitively determine, through whether the first virtual object is still highlighted, whether the first virtual object meets the announcement condition. In this way, it is avoided that the user manually determines whether the first virtual object still meets the announcement condition. For example, the user does not need to manually turn the battle ranking list, or manually check whether a particular virtual prop or a particular virtual material is lost, thereby improving information obtaining efficiency and human computer interaction efficiency of the user.

Operation 1004 is an optional operation, and the first virtual object may alternatively not be highlighted. In this case, it may be considered that the first virtual object is not highlighted at a viewing angle of the first virtual object. However, the first virtual object may still be highlighted at a viewing angle of the second virtual object (certainly, the first virtual object may not be highlighted, and instead only the location of the first virtual object is marked). This is not specifically limited in this embodiment of this application.

In some embodiments, the interaction manner based on the virtual billboard in operations 1001 to 1004 can be triggered only after the game starts and reaches a duration threshold, or can be triggered after points of a player on top of the list reach preset points. In this way, it can be ensured that users can accumulate original equipment, materials, points, and resources at the early stage after the game starts, and can investigate and get familiar with topographic advantages and environmental facilities of the virtual scene to develop a confrontation strategy, a pursuit strategy, or the like. Certainly, the interaction manner may alternatively be automatically triggered after the game starts. Whether there is a triggering condition of the interaction manner is not specifically limited in this embodiment of this application.

Because there may be a plurality of first virtual objects, when observing another first virtual object, a terminal operating a first virtual object may also initiate interaction between different first virtual objects in the interaction manner in the foregoing embodiment. In this case, the first virtual object operated by the terminal is actually equivalent to the second virtual object initiating a challenge in the foregoing embodiment.

Any combination of the foregoing technical solutions may be used to obtain an embodiment of the present disclosure. Details are not described herein.

In the method provided in this embodiment of this application, the virtual billboard set in the virtual scene highlights and prompts the first virtual object meeting the announcement condition, so that the first virtual object can announce, in the virtual billboard, some announcement information of the first virtual object. A quick interaction path based on the virtual billboard is additionally provided without affecting a display function of the virtual billboard. In addition, a user can independently select an announcement mode and an interaction manner, providing the user with a high degree of freedom and operability. Besides, this prevents another user from ignoring information related to a particular virtual object, thereby improving information utilization, information obtaining efficiency, and human computer interaction efficiency of the user in the virtual battle.

In the foregoing embodiment, how the first virtual object selects an announcement mode of the first virtual object and is displayed in the virtual billboard is described in detail. In the embodiments of this application, how a game server side assists terminals on two sides to implement the foregoing interaction solution will be described in detail.

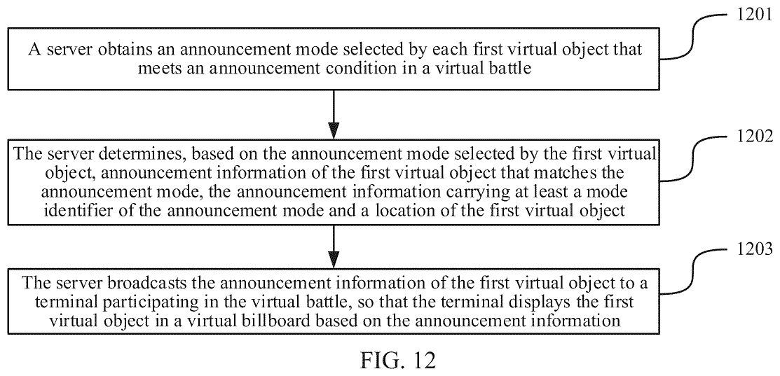

FIG. 12 is a flowchart of an interaction method based on a virtual billboard according to an embodiment of this application. Referring to FIG. 12, this embodiment is performed by an electronic device. The electronic device may be a server (for example, a game server). For example, the server may be provided as the server 140 in the foregoing implementation environment. This embodiment includes the following operations:

1201: A server obtains an announcement mode selected by each first virtual object that meets an announcement condition in a virtual battle.

A manner of determining the announcement condition and the first virtual object is the same as that in operation 301 in the foregoing embodiment, and details are not described again.

In some embodiments, after selecting the announcement mode for the first virtual object based on the method provided in the previous embodiment, a user reports the announcement mode selected by the first virtual object to the server, so that the server can obtain the announcement mode selected by each first virtual object.

1202: The server determines, based on the announcement mode selected by the first virtual object, announcement information of the first virtual object that matches the announcement mode, the announcement information carrying at least a mode identifier of the announcement mode and a location of the first virtual object.

In some embodiments, for each first virtual object, the server configures, according to the announcement mode selected by the first virtual object and obtained in operation 1201, announcement information matching the announcement mode for the first virtual object.

In this embodiment of this application, only an example in which the game service logic provides two or more announcement modes is used for description. In different announcement modes, at least one of announcement information or interaction manners is different. Therefore, first virtual objects selecting different announcement modes have different announcement information configuration logic. If the game service logic provides only one announcement mode, all first virtual objects have the same announcement information configuration logic.

In some embodiments, for example, the game service logic provides two announcement modes. That is, the game service logic provides a first announcement mode and a second announcement mode. The first announcement mode is used to announce the location of the first virtual object, and the second announcement mode is used to announce a location of the first virtual object and provide a navigation function for approaching the first virtual object. In this case, in the first announcement mode, only the location of the first virtual object is broadcast, and the second virtual object still needs to search for the first virtual object in the virtual scene before interacting with the first virtual object. Instead, interaction efficiency of the second announcement mode is higher. This is because in addition to broadcasting the location of the first virtual object, a navigation function for approaching the first virtual object is further supported. In this case, the user can directly airdrop or navigate to the location of the first virtual object by using the navigation function, and confrontation with the first virtual object. Therefore, the confrontation risk of the first virtual object is higher, but more points may be obtained to stabilize a ranking. The human computer interaction efficiency is higher.

In this case, because the location of the first virtual object needs to be announced in both the first announcement mode and the second announcement mode, the announcement information needs to carry the location of the first virtual object. Further, because the first announcement mode does not support a navigation function and the second announcement mode supports the navigation function, a mode identifier of the announcement mode may further be added to the announcement information. In this way, after receiving the announcement information, if a user wants to challenge the first virtual object that enables the second announcement mode, a terminal performs a pathfinding algorithm according to a location of a virtual object of the user as a start point and a location carried in the announcement information as an end point, to obtain an automatic navigation route or flight route. Certainly, if a transfer manner does not require execution of the pathfinding algorithm, only a transfer location (that is, the location carried in the announcement information) needs to be positioned.

In some other embodiments, the game service logic may further provide three or more announcement modes. The location of the first virtual object is announced (that is, announcement information includes the location of the first virtual object) in both the first announcement mode and the second announcement mode, but interaction manners are different in different announcement modes. In some embodiments, the game service logic may further classify multi-level announcement modes according to different announcement information, for example, an appearance announcement mode, a declaration announcement mode, a live streaming announcement mode, and a location announcement mode. Only an appearance of the first virtual object is announced in the appearance announcement mode. The appearance and an announced declaration of the first virtual object are announced in the declaration announcement mode. The appearance, the announced declaration, and a live streaming image of the first virtual object are announced in the live streaming announcement mode. The appearance, the announced declaration, and the location of the first virtual object are announced in the location announcement mode. In this way, if the first virtual object selects the appearance announcement mode, the announcement information carries a display resource of the appearance of the first virtual object. If the first virtual object selects the declaration announcement mode, the announcement information carries the display resource of the appearance of the first virtual object and the announced declaration of the first virtual object. If the first virtual object selects the live streaming announcement mode, the announcement information carries the display resource of the appearance of the first virtual object, the announced declaration of the first virtual object, and the live streaming image (presented in a form of live streaming data stream) of the first virtual object. If the first virtual object selects the location announcement mode, the announcement information carries the display resource of the appearance of the first virtual object, the announced declaration of the first virtual object, and the location of the first virtual object.

If the location announcement mode is further divided into the first announcement mode and the second announcement mode, the announcement information carries the display resource of the appearance of the first virtual object, the announced declaration of the first virtual object, the location of the first virtual object, and a mode identifier of the announcement mode. This is not specifically limited in this embodiment of this application.

1203: The server broadcasts the announcement information of the first virtual object to a terminal participating in the virtual battle, so that the terminal displays the first virtual object in a virtual billboard based on the announcement information.

In some embodiments, after configuring the announcement information of each first virtual object in operation 1202, the server may broadcast the announcement information of each first virtual object to each terminal participating in the virtual battle, so that after receiving the announcement information of each first virtual object, each terminal performs the method in the foregoing embodiments to display each first virtual object in the virtual billboard.

Any combination of the foregoing technical solutions may be used to obtain an embodiment of the present disclosure. Details are not described herein.

In the method provided in this embodiment of this application, the virtual billboard set in the virtual scene highlights and prompts the first virtual object meeting the announcement condition, so that the first virtual object can announce, in the virtual billboard, some announcement information of the first virtual object, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. In addition, a user can independently select an announcement mode and an interaction manner, providing the user with a high degree of freedom and operability and improving human computer interaction efficiency.

In the foregoing embodiments, respective processing procedures are respectively described on a terminal side that initiates a challenge, a terminal side that accepts a challenge (that is, a terminal side displayed in the virtual billboard), and a game server side. However, in the embodiments of this application, an interaction procedure of a user, a client, and a server will be described in detail in a stage in which a player on top of a list selects an announcement mode.

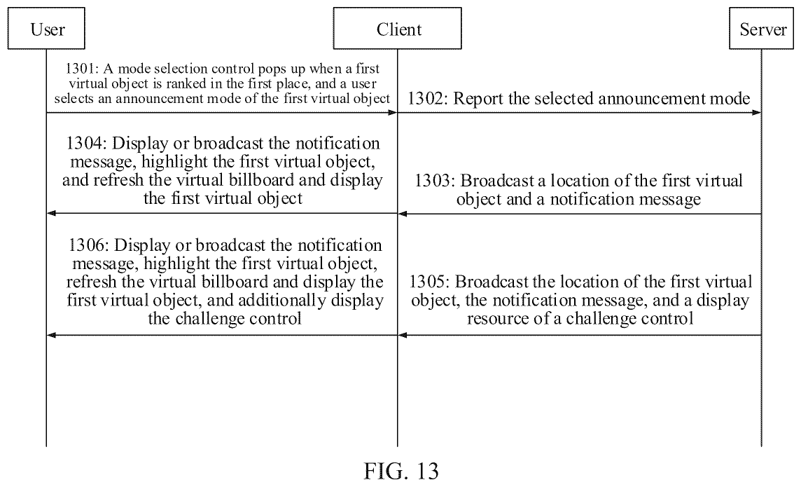

FIG. 13 is an interaction flowchart of an interaction method based on a virtual billboard according to an embodiment of this application. As shown in FIG. 13, the interaction procedure involves a user, a client, and a server. Only an example in which an announcement condition is ranking in the first place in a battle ranking list is used for description. In this case, only a player on top of the list can be displayed in a virtual billboard. Descriptions are provided below:

1301: A mode selection control pops up when a first virtual object is ranked in the first place, and a user selects an announcement mode of the first virtual object.

In some embodiments, after a game starts and reaches a duration threshold, or after points of a player (that is, a user) on top of a list reach preset points, a mode selection control pops up on a terminal of the player on top of the list, to prompt the player on top of the list to select an announcement mode. For example, a first announcement mode is referred to as an ordinary challenge, and a second announcement mode is referred to as an advanced challenge.

1302: A client reports, to a server, the announcement mode selected by the user for the first virtual object.

In some embodiments, according to the announcement mode selected by the player on top of the list in operation 1301, the client reports a corresponding mode identifier to the server.

When the user selects to enable the first announcement mode for the first virtual object, because only the location of the first virtual object is announced in the first announcement mode, operations 1303 and 1304 are performed.

1303: The server broadcasts the location of the first virtual object and a notification message.

In some embodiments, if the user selects the first announcement mode, that is, the player on top of the list selects the ordinary challenge, only the location is announced. The server may perform the following operations: (1) Broadcast the location of the first virtual object controlled by the player on top of the list. (2) Broadcast a notification message, for example, the notification message is “a first virtual object xx announces a location”.

1304: The client displays or broadcasts the received notification message, highlights the first virtual object, and refreshes the virtual billboard and displays the first virtual object.

In some embodiments, when receiving broadcast information from the server, the client can perform the following operations: (1) Display or broadcast a challenge prompt “the first virtual object xx announces the location and challenge is welcome” according to the received notification message. (2) Highlight the first virtual object, for example, both the first virtual object and another virtual object whose distance is less than a distance threshold can view a special mark effect (for example, a special light column effect) of the first virtual object. (3) Refresh the virtual billboard and display the first virtual object, for example, display an appearance or an announced declaration of the first virtual object.

When the user selects to enable the second announcement mode for the first virtual object, because the location of the first virtual object is announced and airdrop of another virtual object is supported in the second announcement mode, operations 1305 and 1306 are performed.

1305: The server broadcasts the location of the first virtual object, a notification message, and a display resource of a challenge control.

In some embodiments, if the user selects the second announcement mode, that is, the player on top of the list selects an advanced challenge, the location of the first virtual object is announced and airdrop of another virtual object is supported. The server may perform the following operations: (1) Broadcast the location of the first virtual object controlled by the player on top of the list. (2) Broadcast a notification message, for example, the notification message is “a first virtual object xx announces a location”. (3) Inform the client to enable an airdrop function, for example, broadcast the display resource of the challenge control.

1306: The client displays or broadcasts the received notification message, highlights the first virtual object, refreshes the virtual billboard and displays the first virtual object, and additionally displays the challenge control.

In some embodiments, when receiving broadcast information from the server, the client can perform the following operations: (1) Display or broadcast a challenge prompt “the first virtual object xx announces the location and challenge is welcome” according to the received notification message. (2) Highlight the first virtual object, for example, both the first virtual object and another virtual object whose distance is less than a distance threshold can view a special mark effect (for example, a special light column effect) of the first virtual object. (3) Refresh the virtual billboard and display the first virtual object, for example, an appearance and an announced declaration of the first virtual object are displayed. Besides, a challenge control is additionally provided to quickly trigger an airdrop function. In addition, a collision detection box is added for the challenge control to help another player shoot the challenge control. A radiographic test interface of a physical engine may be invoked based on the collision detection box, to implement radiographic testing. Whether the challenge control is hit is determined through the radiographic testing. In this way, after another player hits the control, a corresponding UI feedback may be provided.

In the foregoing interaction procedure, on one hand, if a map of the virtual scene is relatively large, in addition to displaying the first virtual object in the virtual billboard, the first virtual object is prompted to make the first virtual object select an announcement mode, for example, only announces the location of the first virtual object (that is, the first announcement mode), or supports airdrop to a place near the first virtual object for interaction while announcing the location of the first virtual object (that is, the second announcement mode). In this way, a system determines a display manner of the first virtual object in the virtual billboard according to the announcement mode selected by the first virtual object. For example, whether to display the challenge control depends on the announcement mode. The challenge control is used to trigger airdrop to a place near the first virtual object for interaction. For another example, a preset challenge declaration or a challenge declaration customized by the first virtual object may be further displayed on the challenge control, to increase an information amount carried by the virtual billboard and improve a degree of display freedom of the challenge control. On the other hand, after a first virtual object selects an announcement mode, when another virtual object (for example, a second virtual object or another first virtual object) approaches within a particular range of the first virtual object, for example, a distance between the first virtual object and the another virtual object is less than a distance threshold, the first virtual object may be highlighted in the virtual scene, or the location of the first virtual object may be identified, so that the first virtual object is more conspicuous to help the another virtual object quickly position the enemy, thereby improving a confrontation strategy and functioning as navigation/road marking/indication to some extent.

In the previous embodiment, the interaction procedure of the user, the client, and the server is described in detail in the stage in which the player on top of the list selects the announcement mode. However, in the embodiments of this application, an interaction procedure of a user, a client, and a server will be described in detail in a stage in which a challenging player initiates a challenge against a player on top of a list.

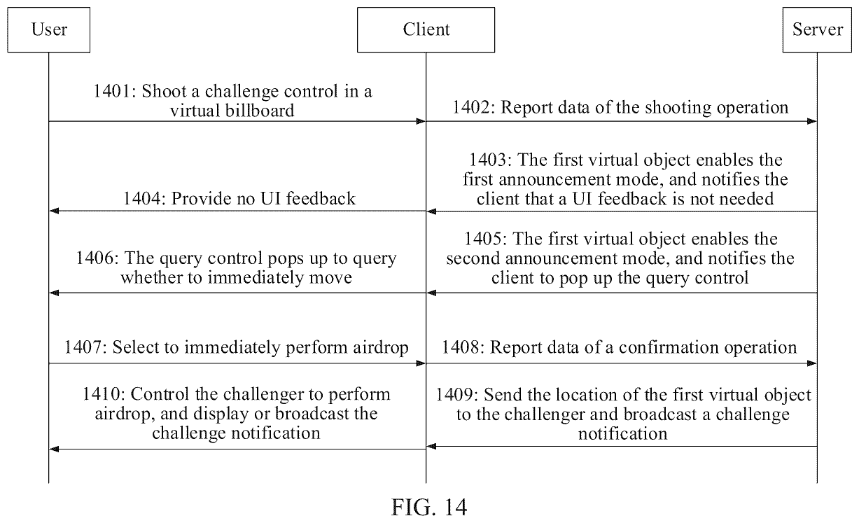

FIG. 14 is an interaction flowchart of an interaction method based on a virtual billboard according to an embodiment of this application. As shown in FIG. 14, the interaction procedure involves a user, a client, and a server. Only an example in which an announcement condition is ranking in the first place in a battle ranking list is used for description. In this case, only a player on top of the list can be displayed in a virtual billboard, and all other players can determine whether to challenge the player on top of the list. Descriptions are provided below:

1401: A user shoots a challenge control in a virtual billboard.

1402: A client reports data of the shooting operation to a server.

When the shooting hits the challenge control, if a first virtual object enables a first announcement mode, that is, a player on top of a list selects only an ordinary challenge, the server performs operations 1403 and 1404.

1403: The server detects that the first virtual object enables the first announcement mode, and notifies the client that a UI feedback is not needed.

1404: The client does not provide a UI feedback to the user.

Whether to provide a UI feedback in operations 1403 and 1404 refers to whether the client pops up a query control on a UI interface. When the first virtual object enables the first announcement mode, only the location of the first virtual object is announced, and airdrop of the second virtual object is not supported. Therefore, although the user performs a shooting operation, the query control for querying whether to immediately perform airdrop does not pop up.

When the shooting hits the challenge control, if a first virtual object enables a second announcement mode, that is, a player on top of a list selects an advanced challenge, the server performs operations 1405 and 1406.

1405: The server detects that the first virtual object enables the second announcement mode, and notifies the client to pop up the query control.

In some embodiments, the server detects that the player on top of the list selects an advanced challenge, and notifies the client to pop up the query control to prompt the user to select whether to immediately perform airdrop.

1406: The client pops up the query control to query whether to immediately move close to the first virtual object.

In some embodiments, the client receives a notification from the server, and pops up the query control to prompt the user to select whether to immediately perform airdrop.

When the client pops up the query control, if another player chooses to immediately perform airdrop, operations 1407 to 1410 are performed.

1407: The user chooses to immediately perform airdrop.

In some embodiments, the user performs a confirmation operation on the query control, and chooses to immediately perform airdrop.

1408: The client reports data of the confirmation operation to the server.

In some embodiments, the client further reports a location and information of the challenger, that is, the second virtual object, to the server.

1409: The server sends the location of the first virtual object to the challenger, that is, the second virtual object, and broadcasts a challenge notification.

In some embodiments, after receiving the information reported by the challenger, the server performs the following operations: (1) Send the location of the player on top of the list to the challenger, that is, send the location of the first virtual object to the second virtual object. (2) Broadcast a challenge notification “a challenger xx initiates a challenge against a player yy on top of the list, let's wait and see” to all players under the server.

1410: The client controls the challenger, that is, the second virtual object, to perform airdrop, and displays or broadcasts the received challenge notification.

In some embodiments, after receiving the location of the player on top of the list and the challenge notification that are sent by the server, the client performs the following operations: (1) Control the challenger to perform airdrop, and play a flight-up special effect, a transfer special effect, a landing special effect, and the like, that is, plan a flight route according to the location of the first virtual object, control the second virtual object to airdrop to the location of the first virtual object, and play a special flight-up effect, a special transfer effect, and a special landing effect. (2) Display or broadcast the challenge notification “a challenger xx initiates a challenge against a player yy on top of the list, let's wait and see” for all players under the server.

In the foregoing interaction procedure, on one hand, if the first virtual object selects an announcement mode (that is, the second announcement mode) in which airdrop close to the first virtual object for interaction is further supported while announcing the location of the first virtual object, another virtual object may initiate, by using the display area of the first virtual object in the virtual billboard, airdrop to the location of the first virtual object, and confront after landing. For example, the display area is clicked on or fired to trigger airdrop. For another example, a challenge control in the display area is clicked on or fired to trigger airdrop. For still another example, the challenge control is displayed only when another virtual object is controlled to approach the display area, and then the challenge control is clicked on or fired to trigger airdrop. In some embodiments, when airdrop is triggered, an animation of displaying the appearance of the first virtual character may further be played, to add immersion to some extent. In some embodiments, a query control pops up before airdrop to increase an airdrop operation link of the user, thereby avoiding a location change caused by an accidental operation of the user on the virtual billboard. On the other hand, if the user selects to perform airdrop close to the first virtual object for confrontation, another virtual object may be controlled to fly close to the first virtual object, and start to perform airdrop, so that after the another virtual object lands, the first virtual object can be found to perform a precise challenge, thereby improving efficiency of human computer interaction between the user and the first virtual object.

FIG. 15 is a schematic structural diagram of an interaction apparatus based on a virtual billboard according to an embodiment of this application. As shown in FIG. 15, the apparatus includes:
a display module 1501, configured to display a virtual billboard in a virtual scene, the virtual billboard displaying at least one target first virtual object, and the first virtual object meeting an announcement condition in a virtual battle; and
a control module 1502, configured to control, in response to a challenge operation performed on any first virtual object, a second virtual object to move towards the first virtual object.

In the apparatus provided in this embodiment of this application, the virtual billboard set in the virtual scene highlights and prompts the first virtual object meeting the announcement condition, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. That is, the user can initiate the challenge operation on the displayed first virtual object directly based on the virtual billboard, to automatically and directly control the second virtual object to move towards the first virtual object to be challenged, and rapidly position and pursue the first virtual object to enable efficient interaction between the virtual objects. First virtual objects do not need to be searched for one by one in the virtual scene, and instead the first virtual object can be quickly positioned based on the announcement of the virtual billboard, thereby improving human computer interaction efficiency.

In some embodiments, the virtual billboard includes at least one display area, each display area is used to display one target first virtual object, and the display module 1501 is configured to:
display the first virtual object and a challenge control for the first virtual object in the display area when the first virtual object enables a second announcement mode, where the challenge control is used to trigger the challenge operation performed on the first virtual object.

In some embodiments, the second announcement mode is used to announce a location of the first virtual object and provide a navigation function for approaching the first virtual object.

In some embodiments, each display area displays at least one of the following: an appearance, an announced declaration, an avatar image, an account nickname, and a live streaming image of the first virtual object.

In some embodiments, the control module 1502 is configured to:
display a query control in response to the challenge operation performed on any first virtual object, where the query control is used to query whether to approach the first virtual object; and
control, in response to a confirmation operation performed on the query control, the second virtual object to move towards the first virtual object. In some embodiments, if the virtual billboard includes at least one display area, and each display area is used to display one target first virtual object, the display module 1501 is further configured to:
display, when the first virtual object enables the second announcement mode, the query control in response to a trigger operation performed on the challenge control in the display area; or
display, when the first virtual object enables the second announcement mode, the query control in response to a trigger operation performed on the display area.

In some embodiments, the display module 1501 is further configured to:
display, in response to a shooting operation performed by on the second virtual object on the challenge control, the query control when the shooting operation hits the challenge control; or
display, in response to a shooting operation performed by on the second virtual object on the display area, the query control when the shooting operation hits the display area.

In some embodiments, the control module 1502 is configured to:
control the second virtual object to move to a movement area of the first virtual object in the virtual scene, and identify a location of the first virtual object in the movement area; or
control the second virtual object to move to a preset range of the first virtual object.

In some embodiments, the control module 1502 is further configured to:
control the second virtual object to fly to an airdrop point of a preset altitude within the preset range;
determine a landing direction that uses the airdrop point as a start point;
determine a landing location of the second virtual object based on the airdrop point and the landing direction; and
control the second virtual object to land to the landing location from the airdrop point.

In some embodiments, the display module 1501 is further configured to:
when a distance between the first virtual object and the second virtual object is less than a distance threshold, identify the location of the first virtual object or highlight the first virtual object.

Any combination of the foregoing technical solutions may be used to obtain an embodiment of the present disclosure. Details are not described herein.

When the interaction apparatus based on a virtual billboard provided in the foregoing embodiment implements interaction based on a virtual billboard, the division of the foregoing functional modules is merely an example for description. In the practical application, the functions may be assigned to and completed by different functional modules according to the requirements, that is, the internal structure of the electronic device is divided into different functional modules, to implement all or some of the functions described above. In addition, the interaction apparatus based on a virtual billboard provided in the foregoing embodiment and the embodiment of the interaction method based on a virtual billboard belong to the same concept. For the specific implementation process, refer to the embodiment of the interaction method based on a virtual billboard. Details are not described herein again.

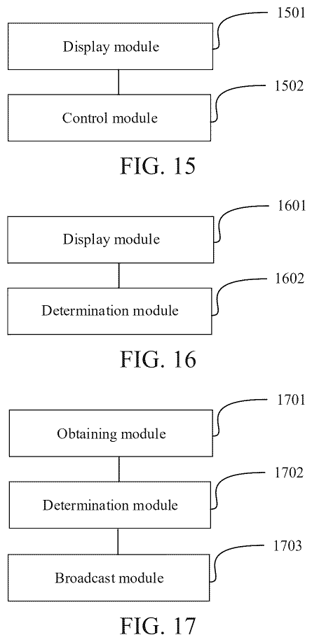

FIG. 16 is a schematic structural diagram of an interaction apparatus based on a virtual billboard according to an embodiment of this application. As shown in FIG. 16, the apparatus includes:
a display module 1601, configured to display a mode selection control in a case in which a first virtual object in a virtual battle meets an announcement condition, the mode selection control being used to prompt the first virtual object to select an announcement mode; and
a determination module 1602, configured to determine, based on the mode selection control, an announcement mode selected by the first virtual object;
the display module 1601 being further configured to display the first virtual object in a virtual billboard of a virtual scene based on the announcement mode selected by the first virtual object.

According to the apparatus provided in this embodiment of this application, the virtual billboard set in the virtual scene highlights and prompts the first virtual object meeting the announcement condition, so that the first virtual object can announce, in the virtual billboard, some announcement information of the first virtual object. A quick interaction path based on the virtual billboard is additionally provided without affecting a display function of the virtual billboard. In addition, a user can independently select an announcement mode and an interaction manner, providing the user with a high degree of freedom and operability. Besides, this prevents another user from ignoring information related to a particular virtual object, thereby improving information utilization, information obtaining efficiency, and human computer interaction efficiency of the user in the virtual battle.

In some embodiments, the virtual billboard includes at least one display area, each display area is used to display one target first virtual object, and the display module 1601 is configured to:
determine the display area of the first virtual object in the virtual billboard; and
display the first virtual object in the display area when the first virtual object enables a first announcement mode; or
display the first virtual object and a challenge control for the first virtual object in the display area when the first virtual object enables a second announcement mode, where the challenge control is used to trigger the challenge operation performed on the first virtual object. In some embodiments, the first announcement mode is used to announce a location of the first virtual object; and the second announcement mode is used to announce a location of the first virtual object and provide a navigation function for approaching the first virtual object.

In some embodiments, the display area displays at least one of the following: an appearance, an announced declaration, an avatar image, an account nickname, and a live streaming image of the first virtual object.

In some embodiments, the mode selection control includes a mode selection pop-up window, and the first announcement mode and the second announcement mode are displayed in the mode selection pop-up window.

In some embodiments, the display module 1601 is further configured to:
highlight the first virtual object in the virtual scene if the first virtual object is not eliminated.

Any combination of the foregoing technical solutions may be used to obtain an embodiment of the present disclosure. Details are not described herein.

When the interaction apparatus based on a virtual billboard provided in the foregoing embodiment implements interaction based on a virtual billboard, the division of the foregoing functional modules is merely an example for description. In the practical application, the functions may be assigned to and completed by different functional modules according to the requirements, that is, the internal structure of the electronic device is divided into different functional modules, to implement all or some of the functions described above. In addition, the interaction apparatus based on a virtual billboard provided in the foregoing embodiment and the embodiment of the interaction method based on a virtual billboard belong to the same concept. For the specific implementation process, refer to the embodiment of the interaction method based on a virtual billboard. Details are not described herein again.

FIG. 17 is a schematic structural diagram of an interaction apparatus based on a virtual billboard according to an embodiment of this application. As shown in FIG. 17, the apparatus includes:
an obtaining module 1701, configured to obtain an announcement mode selected by each first virtual object that meets an announcement condition in a virtual battle;
a determination module 1702, configured to determine, based on the announcement mode selected by the first virtual object, announcement information of the first virtual object that matches the announcement mode, the announcement information carrying at least a mode identifier of the announcement mode and a location of the first virtual object; and
a broadcast module 1703, configured to broadcast the announcement information of the first virtual object to a terminal participating in the virtual battle, so that the terminal displays the first virtual object in a virtual billboard based on the announcement information.

According to the apparatus provided in this embodiment of this application, the virtual billboard set in the virtual scene highlights and prompts the first virtual object meeting the announcement condition, so that the first virtual object can announce, in the virtual billboard, some announcement information of the first virtual object, to prevent a user from ignoring information related to a particular virtual object, thereby improving information utilization and information obtaining efficiency of the user in the virtual battle. Further, a quick interaction path based on the virtual billboard is additionally provided without affecting a display function of the virtual billboard. In addition, a user can independently select an announcement mode and an interaction manner, providing the user with a high degree of freedom and operability and improving human computer interaction efficiency.

In some embodiments, the announcement mode includes a first announcement mode and a second announcement mode, the first announcement mode is used to announce a location of the first virtual object; and the second announcement mode is used to announce a location of the first virtual object and provide a navigation function for approaching the first virtual object.

Any combination of the foregoing technical solutions may be used to obtain an embodiment of the present disclosure. Details are not described herein.

When the interaction apparatus based on a virtual billboard provided in the foregoing embodiment implements interaction based on a virtual billboard, the division of the foregoing functional modules is merely an example for description. In the practical application, the functions may be assigned to and completed by different functional modules according to the requirements, that is, the internal structure of the electronic device is divided into different functional modules, to implement all or some of the functions described above. In addition, the interaction apparatus based on a virtual billboard provided in the foregoing embodiment and the embodiment of the interaction method based on a virtual billboard belong to the same concept. For the specific implementation process, refer to the embodiment of the interaction method based on a virtual billboard. Details are not described herein again.

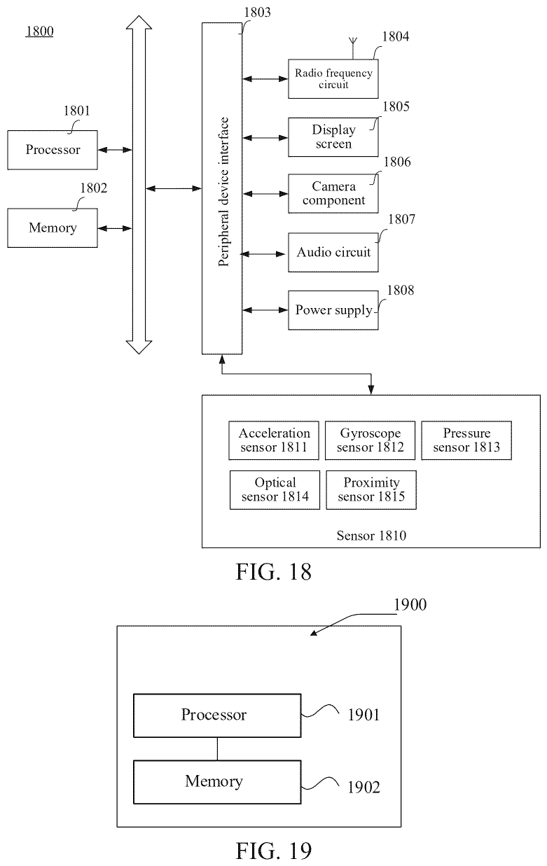

FIG. 18 is a schematic structural diagram of an electronic device according to an embodiment of this application. As shown in FIG. 18, the electronic device is, for example, a terminal 1800. The terminal 1800 can be a terminal that controls a second virtual object or a terminal that controls a first virtual object. This is not specifically limited in this embodiment of this application. In some embodiments, a device type of the terminal 1800 includes: a smartphone, a tablet computer, a moving picture experts group audio layer III (MP3) player, or a moving picture experts group audio layer IV (MP4) player, a laptop computer, or a desktop computer. The terminal 1800 may also be referred to as another name such as user equipment, a portable terminal, a laptop terminal, or a desktop terminal.

Generally, the terminal 1800 includes: a processor 1801 and a memory 1802.

In some embodiments, the processor 1801 may include one or more processing cores, for example, may be a 4-core processor or an 8-core processor. In some embodiments, the processor 1801 may be implemented in at least one hardware form of a digital signal processor (DSP), a field-programmable gate array (FPGA), and a programmable logic array (PLA). In some embodiments, the processor 1801 includes a main processor and a coprocessor. The main processor is configured to process data in an active state, also referred to as a central processing unit (CPU). The coprocessor is a processor with low power consumption configured to process data in a standby state. In some embodiments, the processor 1801 may be integrated with a graphics processing unit (GPU). The GPU is configured to render and draw content that needs to be displayed on a display screen. In some embodiments, the processor 1801 further includes an artificial intelligence (AI) processor. The AI processor is configured to process computing operations related to machine learning.

In some embodiments, the memory 1802 includes one or more computer-readable storage media, and in some embodiments, the computer-readable storage medium is non-transitory. In some embodiments, the memory 1802 further includes a high-speed random access memory and a nonvolatile memory, for example, one or more disk storage devices or flash storage devices. In some embodiments, the non-transitory computer-readable storage medium in the memory 1802 is configured to store at least one program code, and the at least one program code is configured to be executed by the processor 1801 to implement the interaction method based on a virtual billboard provided in embodiments of this application.

In some embodiments, the terminal 1800 further includes: a peripheral device interface 1803 and at least one peripheral device. The processor 1801, the memory 1802, and the peripheral device interface 1803 may be connected by a bus or a signal cable. Each peripheral device can be connected to the peripheral device interface 1803 by using a bus, a signal cable, or a circuit board. Specifically, the peripheral device includes: at least one of a radio frequency circuit 1804, a display screen 1805, a camera assembly 1806, an audio circuit 1807, and a power supply 1808.

In some embodiments, the terminal 1800 further includes one or more sensors 1810. The one or more sensors 1810 include but are not limited to: an acceleration sensor 1811, a gyroscope sensor 1812, a pressure sensor 1813, an optical sensor 1814, and a proximity sensor 1815.

A person skilled in the art can understand that the structure shown in FIG. 18 does not constitute a limitation on the terminal 1800, and can include more or fewer components than those shown in the figure, or combine some components, or use different component arrangements.

FIG. 19 is a schematic structural diagram of an electronic device according to an embodiment of this application. The electronic device 1900 can be provided as a server, such as a game server. The electronic device 1900 may vary greatly due to different configurations or performance. The electronic device 1900 includes one or more processors 1901 and one or more memories 1902. The processor can be, for example, a central processing unit (CPU). The memory 1902 stores at least one computer program, and the at least one computer program is loaded and executed by the one or more processors 1901 to implement the interaction method based on a virtual billboard provided in the foregoing embodiments. In some embodiments, the electronic device 1900 further includes components such as a wired or wireless network interface, a keyboard, and an input/output interface, to facilitate input and output. The electronic device 1900 further includes another component configured to implement a function of a device. Details are not further described herein.

In an exemplary embodiment, a non-transitory computer-readable storage medium, for example, a memory including at least one computer program is further provided. The at least one computer program may be executed by a processor in an electronic device to implement the interaction method based on a virtual billboard provided in the foregoing embodiments. For example, the computer-readable storage medium includes a read-only memory (ROM), a random access memory (RAM), a compact disc read-only memory (CD-ROM), a magnetic tape, a floppy disk, and an optical data storage device.

In an exemplary embodiment, a computer program product is further provided, including one or more computer programs, and the one or more computer programs are stored in a non-transitory computer-readable storage medium. One or more processors of an electronic device can read the one or more computer programs from the computer-readable storage medium, and the one or more processors execute the one or more computer programs to enable the electronic device to perform the interaction method based on a virtual billboard in the foregoing embodiments.

A person of ordinary skill in the art can understand that all or some of the operations of the embodiments may be implemented by hardware or a program instructing relevant hardware. In some embodiments, the program is stored in a non-transitory computer-readable storage medium. In some embodiments, the storage medium mentioned above is a read-only memory, a magnetic disk, an optical disc, or the like.

The foregoing descriptions are merely optional embodiments of this application, but are not intended to limit this application. Any modification, equivalent replacement, or improvement made within the spirit and principle of this application shall fall within the protection scope of this application.

What is claimed is:

1. An interaction method on a virtual billboard performed by a computer device, comprising:
displaying a virtual billboard in a virtual scene, the virtual billboard including at least one first virtual object meeting an announcement condition in a virtual battle; and
in response to a challenge operation performed on the first virtual object, controlling a second virtual object to move towards the first virtual object.

2. The method according to claim 1, wherein the displaying the virtual billboard in the virtual scene comprises:
displaying the first virtual object and a challenge control for the first virtual object in a display area when the first virtual object enables a second announcement mode, wherein the challenge control is used to trigger the challenge operation performed on the first virtual object.

3. The method according to claim 2, wherein the second announcement mode is used to announce a location of the first virtual object and provide a navigation function for approaching the first virtual object.

4. The method according to claim 2, wherein each display area further displays at least one of the following: an appearance, an announced declaration, an avatar image, an account nickname, and a live streaming image of the first virtual object.

5. The method according to claim 1, wherein the controlling the second virtual object to move towards the first virtual object comprises:
displaying a query control in response to the challenge operation performed on the first virtual object; and
in response to a confirmation operation performed on the query control, controlling the second virtual object to move towards the first virtual object.

6. The method according to claim 5, wherein the displaying the query control in response to the challenge operation performed on the first virtual object comprises:
when the first virtual object enables the second announcement mode, displaying the query control in response to a trigger operation performed on the challenge control in the display area; and
when the first virtual object enables the second announcement mode, displaying the query control in response to a trigger operation performed on the display area.

7. The method according to claim 1, wherein the controlling the second virtual object to move towards the first virtual object comprises:
controlling the second virtual object to move to a movement area of the first virtual object in the virtual scene, and identifying a location of the first virtual object in the movement area; and
controlling the second virtual object to move to a preset range of the first virtual object.

8. The method according to claim 1, further comprising:
when a distance between the first virtual object and the second virtual object is less than a distance threshold, identifying a location of the first virtual object in the virtual scene and highlighting the location of the first virtual object.

9. A computer device, comprising one or more processors and one or more memories, the one or more memories having at least one computer program stored therein, and the at least one computer program being loaded and executed by the one or more processors and causing the computer device to implement an interaction method on a virtual billboard including:
displaying a virtual billboard in a virtual scene, the virtual billboard including at least one first virtual object meeting an announcement condition in a virtual battle; and
in response to a challenge operation performed on the first virtual object, controlling a second virtual object to move towards the first virtual object.

10. The computer device according to claim 9, wherein the displaying the virtual billboard in the virtual scene comprises:
displaying the first virtual object and a challenge control for the first virtual object in a display area when the first virtual object enables a second announcement mode, wherein the challenge control is used to trigger the challenge operation performed on the first virtual object.

11. The computer device according to claim 10, wherein the second announcement mode is used to announce a location of the first virtual object and provide a navigation function for approaching the first virtual object.

12. The computer device according to claim 10, wherein each display area further displays at least one of the following: an appearance, an announced declaration, an avatar image, an account nickname, and a live streaming image of the first virtual object.

13. The computer device according to claim 9, wherein the controlling the second virtual object to move towards the first virtual object comprises:
displaying a query control in response to the challenge operation performed on the first virtual object; and
in response to a confirmation operation performed on the query control, controlling the second virtual object to move towards the first virtual object.

14. The computer device according to claim 13, wherein the displaying the query control in response to the challenge operation performed on the first virtual object comprises:
when the first virtual object enables the second announcement mode, displaying the query control in response to a trigger operation performed on the challenge control in the display area; and
when the first virtual object enables the second announcement mode, displaying the query control in response to a trigger operation performed on the display area.

15. The computer device according to claim 9, wherein the controlling the second virtual object to move towards the first virtual object comprises:
controlling the second virtual object to move to a movement area of the first virtual object in the virtual scene, and identifying a location of the first virtual object in the movement area; and
controlling the second virtual object to move to a preset range of the first virtual object.

16. The computer device according to claim 9, wherein the method further comprises:
when a distance between the first virtual object and the second virtual object is less than a distance threshold, identifying a location of the first virtual object in the virtual scene and highlighting the location of the first virtual object.

17. A non-transitory computer-readable storage medium, having at least one computer program stored therein, the at least one computer program being loaded and executed by a processor of a computer device and causing the computer device to implement an interaction method on a virtual billboard including:
displaying a virtual billboard in a virtual scene, the virtual billboard including at least one first virtual object meeting an announcement condition in a virtual battle; and
in response to a challenge operation performed on the first virtual object, controlling a second virtual object to move towards the first virtual object.

18. The non-transitory computer-readable storage medium according to claim 17, wherein the displaying the virtual billboard in the virtual scene comprises:
displaying the first virtual object and a challenge control for the first virtual object in a display area when the first virtual object enables a second announcement mode, wherein the challenge control is used to trigger the challenge operation performed on the first virtual object.

19. The non-transitory computer-readable storage medium according to claim 17, wherein the controlling the second virtual object to move towards the first virtual object comprises:
displaying a query control in response to the challenge operation performed on the first virtual object; and
in response to a confirmation operation performed on the query control, controlling the second virtual object to move towards the first virtual object.

20. The non-transitory computer-readable storage medium according to claim 17, wherein the controlling the second virtual object to move towards the first virtual object comprises:
controlling the second virtual object to move to a movement area of the first virtual object in the virtual scene, and identifying a location of the first virtual object in the movement area; and
controlling the second virtual object to move to a preset range of the first virtual object.
